(19) United States
(12) Patent Application Publication
(10) Pub. No.: US 2004/0267647 A1
(43) Pub. Date: Dec. 30, 2004

(54) Capital market products including securitized life settlement bonds and methods of issuing, servicing and redeeming same

(76) Inventor: Dorion P. Brisbois, Providenc Ales (TC)

Correspondence Address: ANTHONY H. HANDAL, KIRKPATRICK & LOCKHART, LLP, 599 LEXINGTON AVENUE, 31ST FLOOR, NEW YORK, NY, 10022-6030, US

(21) Appl. No.: 10/610,374

(22) Filed: Jun. 30, 2003

(51) Int. Cl. G06F 17/60

(52) U.S. Cl. 705/35

(57) ABSTRACT

Disclosed are novel capital market products, e.g. bonds, equities and like, employing a life settlement policy pool as collateral against repayment of principal. One embodiment is a securitized life settlement bond collateralized by a pool of from 100 to 1,000 senior life settlement policies each bearing death benefits expected to mature within the bond term. The aggregate death benefit value of the life policies can be about 10% greater than the face value of the capital product. The collateral can include an investment portfolio, e.g. of guaranteed investment contracts, to pay the premiums on the life policies thereby ensuring the policies will remain in force and eventually yield death benefits. Another investment portfolio, optionally also of guaranteed investment contracts, can be included in the collateral product to guarantee payment of the bond interest or coupon. Optionally, a bond credit guarantee can be purchased to ensure timely payment of benefits on insureds who outlive their life expectancies. Preferably, the life policies are subject to stringent selection procedure to optimize the probability and timing of the death payments. The death benefits can be used to redeem the bond. The collateral can be structured to be worthy of an investment grade rating or better. By collateralizing both the bond coupon and redemption of principal up front with highly credible products using highly rated instruments, a favorable rating can be obtained for the bond. In some embodiments the bond can be offered at from 100 to 150 points over corresponding Treasury bonds and have an A or even an AA rating or better.

### STATEMENT REGARDING FEDERALLY SPONSORED RESEARCH OR DEVELOPMENT

(Not applicable.)

### BACKGROUND OF THE INVENTION

The present invention relates to novel capital market products including securitized life settlement bonds as well as methods of issuing, servicing and redeeming same. More particularly, the invention provides inter alia, a life settlement bond employing a novel pool of life settlement policies which bond can qualify for an investment grade rating.

A significant proportion of the United States population holds life insurance policies on which they pay annual premiums for many years. Policies of interest to the present application have substantial death benefits which will accrue to a designated beneficiary upon the death of the policyholder. As people age, the rationale for the policy may diminish, for example, offspring may become self-sufficient, and the policyholder may become willing to relinquish control over future death benefits in exchange for current cash.

To obtain financial benefits from an existing life insurance policy, the policy holder presently has several options including: borrowing against the cash value of the life insurance policy; cashing out the policy with the life insurance carrier for the available cash surrender value; taking advantage of an “accelerated benefits program” rider if offered by the life insurance carrier and if the insured is eligible; selling the life insurance policy in a life settlement; and borrowing from friends or family using the life insurance policy as collateral to secure the loan.

A “senior settlement” is the sale of a life insurance policy insuring the life of a senior citizen, usually taken to be a person over age 65, in return for a lump-sum of cash that is in excess of the policy's available cash values.

A “viatical settlement” is a cash payment from the face value of a life insurance policy payable to an individual of any age living with a terminal or life-shortening illness.

The percentage of the face amount of a life insurance policy that is paid in full to a seller at closing is usually determined by: the estimated life expectancy and medical condition of the insured; the outstanding amount of any loans pledged against the policy; the cost of premiums necessary to keep the policy in force; the credit and solvency ratings of the insurance company; and prevailing interest rates. This cash surrender value is usually a small proportion of the face value, often as low as 10-15 percent or less of the face value and it may be further reduced by early surrender penalties.

It is estimated, in 2003, that there are in the United States approximately $400+ billion of outstanding life policies of people age 65 and over which represent an attractive opportunity for securitization.

“Securitization” is a process wherein illiquid assets are converted into capital market instruments by pooling similar cash-generating assets, for example mortgages or credit card receivables, and repackaging the underlying cash flows to make them attractive to investors. A problem encountered in attempting to securitize life insurance policies or life settlements is the lack of an underlying cash flow. Unlike mortgages, credit card or other receivables which have been securitized in recent years and provide a well-known class of investment described as “asset-backed securities”, a pool of life insurance policies offers only a limited number of lump sum payments to be made at unknowable times in the future, possibly many years into the future. Such an uncertain revenue prognosis does not provide a satisfactory means for generating the regular cash payments usually required to service a capital market debt or equity instrument.

Furthermore, life policies, rather than providing a constant revenue stream, have high maintenance costs in the form of annual premiums which must be timely paid if the full benefit is eventually to be collected. Thus, if an insured substantially outlives his or her life expectancy, instead of receiving a substantial capital payment at a particular time, an investor in the policy may be faced with continuing outlays for payment of premiums. Also, clear title to the policy and benefits must be formally obtained on behalf of the bond issuer, or their agent obtaining which requires participation by all the individual policyholders and any other person who may claim an interest in the policy benefits, and completion of a number of formalities, an operation which may become dauntingly complex for a large pool of policies. In contrast, receivable and mortgage pools can be assigned without customer participation or authorization. Such problems cause life insurance policies to be a particularly unattractive medium for investment.

It is applicant's belief that known efforts that have been made to securitize life settlement policies or to bring to the capital market products relying upon life settlement policies as collateral, notwithstanding the foregoing difficulties, have employed equity-based structures and have been considered unsuccessful. Some such efforts may have failed to realize the anticipated death benefits while others may have failed to pay premiums, allowing policies to lapse. It is believed that the policy pools employed in such prior efforts or proposals did not employ an actuarially sound basis for structuring the pool.

Even with this insight, difficulties still arise in attempting to securitize life insurance policies from the paucity, or unavailability, of actuarial figures that will help provide a reliable guide to the returns that may be expected from a life settlement pool. Absent credible forecasts of the timing and amount of the death benefits to be generated by the life insurance policy pool, it is difficult to structure a capital market product that is sufficiently sound to appeal to investors. The foregoing drawbacks to the utilization of life insurance policies as collateral and the difficulties encountered with life policy-based equity investments point away from the use of life insurance policies to satisfy the stringent requirements encountered in collateralizing debt instruments such as bonds.

The patent literature contains some proposals of general interest to the background of the invention, but no proposal known to applicant solves the foregoing problems.

For example, Chodes United States Patent Application 20030023544 discloses, in the abstract, a method and system for affluent retiree and other beneficiaries of non-assignable benefits such as Social Security payments to receive a lump sum payment in return for agreeing to direct future benefits to an account at a preselected financial institution. On a periodic basis, pursuant to participant authorization, the account is swept of funds, which are transferred to a second account for the benefit of the lender or their agent. At paragraph [0006], Chodes describes the high net worth life settlement market and some of the reasons motivating wealthy seniors to pursue such settlements which are described as involving discounts to face of 60% to 90%. Chodes does not suggest a capital market product employing life insurance policies as collateral.

Meyer, et al. U.S. Pat. No. 5,907,828 discloses a system and method for implementing and administering a lender-owned life insurance policy pool on behalf of the lender to improve loan profitability. However Meyer et al. '828 does not disclose the use of a life insurance pool to back a marketable security.

Kirksey U.S. Pat. No. 6,460,021 discloses, in the abstract, a collaterally secured debt obligation, for example a bond, which is backed by a group of owners of property such as homes or commercial real estate, where each owner provides cross-collateralized lien and loan agreements promising to pay to the issuing entity his or her periodic payments to the entity and to pay, if defaults occur, each and every other owner's periodic payments. Real estate is not at all similar to a life insurance policy as a collateral vehicle and the requirement to obtain the cooperation and commitment to one another of each of a number of individual owners of a stake in the collateral pool, in Kirksey's method, is highly unattractive.

Meyer et al. U.S. Pat. No. 6,330,541 discloses, at column 1, lines 8-23, a system and method for controlling and securitizing the cash value growth and/or death benefits of a large group of insurance policies. A particular embodiment relates to bank purchase of a pool of life insurance policies on its borrowers wherein death benefits go to the bank to cover the outstanding mortgage amounts. The disclosed method monitors death rates and interest rates in the policy pool and adjusts premium rates and death benefit levels in order to control cash value growth and to generate cash flow from death benefits that may be securitized. According to Meyer et al. '541 at column 1, lines 32-35, large positive cash value growth can adversely affect a company's liquidity and investment and business options, due to regulatory limitations on the amount of investment a company may have in life insurance.

In the example of FIG. 8, of Meyer et al. '541, described at column 4, line 60 to column 5, line 9, after higher than desired cash value growth in year five, the death benefit level is raised in year six to increase the cost of insurance and reduce excess cash value growth. In years eight and nine, the death benefit level is adjusted downward, to more closely match the amortized mortgage amount for those years.

Meyer et al. '541 mentions that it would be desirable to have a computer system to securitize at least a portion of the cash flow (column 1, lines 54-56) and describes the use of cash values in the policies as security in the transaction, presumably the transaction wherein investment returns are paid back to the policies (column 12, lines 32-37). Meyer et al. '541 does not describe how the security provided by the cash values in the policies is to be used.

Meyer et al. '541 also discloses at column 12, line 46 to column 13, line 3, managing a life insurance policy pool to generate a consistent cash flow from death benefits paid as the insureds die. A first premium is determined, the system accesses an actuarial mortality table, and determines the expected number of deaths in the pool, then modifies one of the policy terms, for example the death benefits, so that the determined number of deaths produces a desired cash flow. A portion of the cash flow may be sold to a third party at a system-determined value, for example in a private placement (column 3, lines 15-16). However, Meyer et al. '541 does not disclose use of a life insurance pool as collateral for a marketable security. Nor does Meyer et al, suggest creation of a capital market product securitized by life insurance policies which could be worthy of an investment grade rating by a rating agency.

The foregoing description of background art may include insights, discoveries, understandings or disclosures, or associations together of disclosures, that were not known to the relevant art prior to the present invention but which were provided by the invention. Some such contributions of the invention may have been specifically pointed out herein, whereas other such contributions of the invention will be apparent from their context. Merely because a document may have been cited here, no admission is made that the field of the document, which may be quite different from that of the invention, is analogous to the field or fields of the invention.

### BRIEF SUMMARY OF THE INVENTION

The present invention solves a problem. It solves the problem of providing a capital market product securitized by life insurance policies which is capable of an investment grade rating by a rating agency. This problem is solved by providing a securitized life settlement bond comprising a commercial bond collateralized by a pool of life settlement policies each bearing death benefits wherein the policies are selected from available policies for death benefit collectability, the death benefits collected being usable for redemption of the bond. Other capital market products are provided using comparable collateral. The invention also provides methods of issuing, servicing and redeeming such a bond.

The bond can be issued by a bond issuer and have a term for redemption. Each life settlement policy in the life settlement policy pool has an insured party and preferably the life expectancy of each insured party is less than the term of the bond. Furthermore, optionally each life expectancy can be freshly determined on behalf of the bond issuer prior to inclusion in the life settlement policy pool.

Desirably, the life expectancy of each insured party is at least one year less than the term of the bond. The life settlement policies can be organized in the pool in multiple cohorts having different life expectancies. The life settlement policies can be organized into from two to five cohorts each cohort having a proportion of the total face value of policies in the life settlement policy pool within about 30 percent of an equal proportion.

Advantageously, the bond can comprise a collateral product which includes the life settlement policy pool and also includes an investment instrument, for example a guaranteed investment contract, designed to provide income to pay premiums on the life insurance policies in the pool. If desired the collateral pool can include a further investment instrument to provide income to pay the coupon on the bond. In this way, the integrity of the bond can be assured.

In preferred embodiments, the present invention solves the problem of securitizing life insurance policies in a manner that substantially eliminates or controls uncertainties arising from the uncontrollability of the timing of the payment of death benefits.

A valuable feature of the invention comprises applying sophisticated actuarial processes to a policy procurement protocol to effectively address some or all of the above-stated prior market deficiencies.

In addition, the invention provides life settlement bonds or related investment indentures with specific models and methods for implementation and life insurance policy selection and procurement processes that can provide an asset base and benefit collection methodology that may yield an attractive return on investment.

In another aspect, the invention provides a methodology for identifying or detecting policy maturity and an efficient benefit claims protocol established at the point of policy procurement which can be operated particularly efficiently by an entity or individuals responsible for having procured the policies for inclusion in the life settlement policy pool.

Another advantage of the invention is that it can provide a life settlement bond of good financial quality that can be sold at full face value, unlike a discount bond.

In a further aspect, the invention provides a method of servicing and redeeming a bond comprising:

a) making recurring interest payments from income received from an income instrument portfolio maintained in a bond trust; and

b) redeeming the bond with death benefit funds received from a pool of life insurance policies maintained in the bond trust.

The method can include paying premiums on the life insurance policies from income received from a further income instrument portfolio maintained in a bond trust. If desired, the death benefit funds can include bond credit guarantee payments for insureds outliving their calculated life expectancies.

In another aspect the invention provides a method of issuing a bond having a bond term comprising assembling a collateral product comprising a pool of life insurance policies bearing death benefits calculated to be receivable within the bond term, the life insurance policies being subject to recurring premium payments and the collateral product further comprising an income instrument portfolio providing income for making the premium payments and the method further comprising collateralizing the bond with the collateral product and issuing the bond.

In a still further aspect, the invention provides a capital market product having a face value and being collateralized by a collateral product comprising

a) a life settlement policy pool of life insurance policies bearing death benefits and subject to payment of recurring premiums to maintain the death benefits in force, the policies being selected to provide an expectation of the receipt of death benefit payments within a planned time frame, the death benefits having an aggregate value at least as great as the face value of the capital market product; and

b) an income instrument portfolio to generate income to provide funds to pay the life insurance policy premiums.

The capital market product can be selected from the group consisting of short-, medium- and long-term bonds and notes, equity-based investment vehicles and securities, mixed debt-equity instruments and derivatives and other investment vehicles.

The inventive capital market product provides a broad range of choices for generating liquidity from the value inherent in the life settlement policy pool which pool can be structured in a novel manner as described herein to enhance the expectation of receipt of death benefits and the quality of the capital market product.

### BRIEF DESCRIPTION OF THE SEVERAL VIEWS OF THE DRAWING

Some embodiments of the invention, and of making and using the invention, as well as the best mode contemplated of carrying out the invention, are described in detail below, by way of example, with reference to the accompanying drawings, in which like reference characters designate like elements throughout the several views, and in which:

FIG. 1 is a schematic block diagram of a method of issuing, servicing and redeeming a life settlement bond collateralized with a pool of life insurance policies, according to one embodiment of the invention;

FIG. 2 is a block flow diagram illustrating an embodiment of process flow in practicing the inventive method illustrated in FIG. 1;

FIG. 3 is a block flow diagram illustrating an embodiment of post-issuance process flow useful in practicing the inventive method illustrated in FIG. 1;

FIG. 4 is a block flow diagram similar to FIG. 1 of another embodiment of the bond issuing, servicing and redeeming method of the invention which embodiment includes most or all of the features of the embodiment of the invention illustrated in FIGS. 1-3;

FIG. 5 is a schematic block diagram of one embodiment of financial structure suitable for a life settlement bond produced by the method of the invention illustrated in FIG. 4;

FIG. 6 is a block flow diagram of a policy qualification and procurement procedure useful in the practice of the invention;

FIG. 7 is a schematic block diagram showing some possible functions of an administrative services provider who can be employed in practicing the embodiment of the invention illustrated in FIG. 4; and

FIG. 8 is a schematic block diagram of a financial collateral product according to a further embodiment of the invention.

### DETAILED DESCRIPTION OF THE INVENTION

The following more detailed description of the invention is intended to be read in the light of, and in context with, the preceding summary and background descriptions.

While not so limited, the invention is particularly suitable for implementation in the United States under Rule 144A of the Securities Act of 1933 or other equivalent legislation that may be enacted. This rule provides for the private resale or private placement of securities into a market restricted to institutional investors, and permits the issuer to avoid some of the more onerous requirements that the Act provides for the sale of securities to the general public. Preferably, although not necessarily, the life settlement bond of the invention is designed to be exempt from registration with the SEC (the United States Securities and Exchanges Commission). The principles of the invention can also be applied to other investment interests, for example, to equity instruments or issues, publicly distributed and publicly traded bond or equity securities, private investment modalities, and the issuance and servicing of any of the foregoing investment vehicles, if desired.

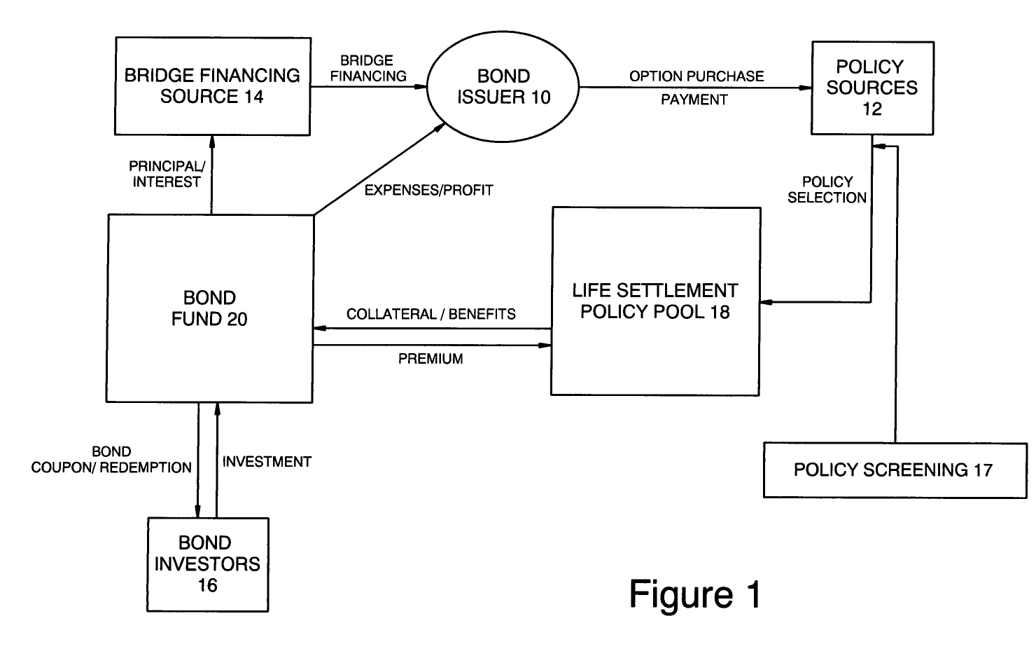

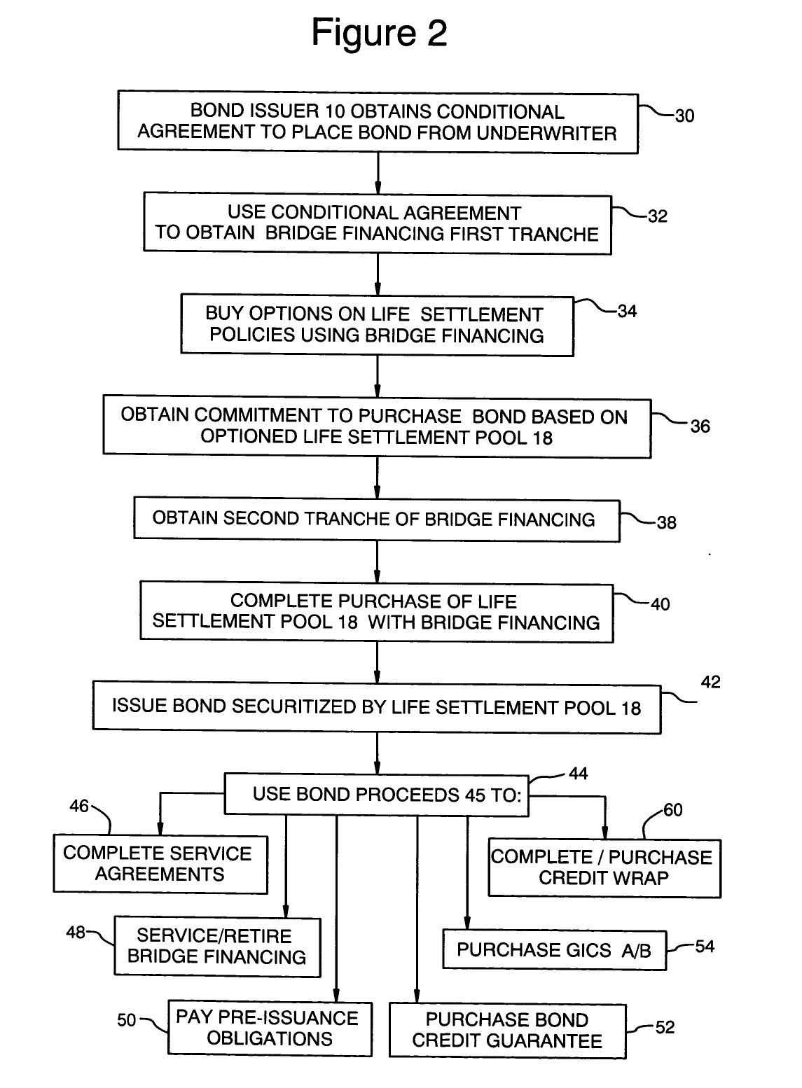

Referring to FIG. 1, the several parties to the bond issuance and servicing method shown comprise a bond issuer 10, policy sources 12, a bridge financing source 14 and a bond investor or investors 16. By applying policy screening 17 using policy due diligence processing and actuary tables to the policies available from policy sources 12, as taught by the invention described herein, a novel, investment grade collateralized life settlement policy pool 18 is created. Employing life settlement policy pool 18 and a bond fund 20 collateralized by policy pool 18, the parties cooperate under the guidance of the bond issuer 10 to issue, service and redeem or retire the life settlement bond using a method such as that illustrated in FIG. 2. In effect the policies in policy pool 18 are securitized by the method of the invention. In other words, the life settlement life insurance policies are bundled into a package which underpins a marketable security, one application of which is the inventive life settlement bond described in detail herein.

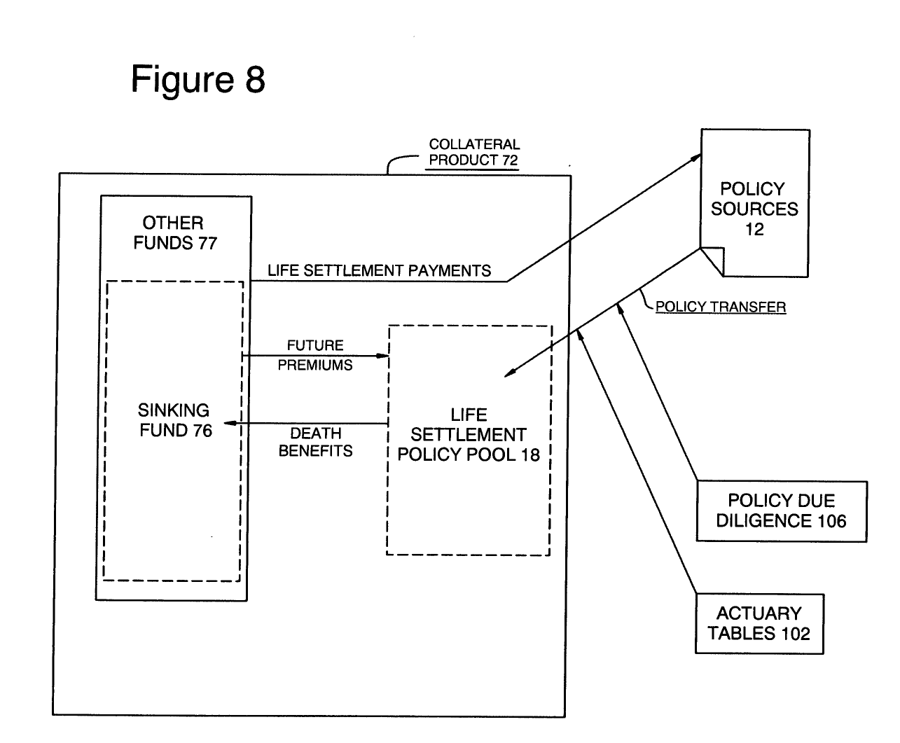

Other investment applications are contemplated as being able to beneficially employ the novel life policy procurement and management functions described herein, some of which are described hereinbelow in connection with FIG. 8.

Referring now to FIGS. 1 and 2 together, the illustrated bond issuance and servicing method shown commences, in step 30, with bond issuer 10 obtaining a conditional agreement to place the bond from an underwriter (not shown). Such conditional agreement or indication of interest, may be based upon a business model, plan of the proposed bond structure or other presentation made by bond issuer 10. The subject life settlement bonds of the present invention are usually long term debt securities, the term of which is fixed at issuance, e.g. to a number in the range of from 5 to 10 years. However, the novel capital products of the invention may also comprise other securities, for example shorter term bonds or notes or derivatives.

Bond issuer 10 may be any suitably qualified and reputable individual, corporation or partnership having the means to structure and implement the method, bond and other instruments of the invention. Preferably however, but not necessarily, bond issuer 10 is an entity having at least $10 mm in assets, at the appropriate time, or other required amount, that will qualify bond issuer 10 as an institutional investor, pursuant to United States law. This status is helpful in enabling the implementation of certain aspects of the invention, such as the purchase of guaranteed investment contracts, as is described more fully hereinbelow.

In step 32, bond issuer 10 uses the underwriter's conditional agreement to obtain an initial tranche of bridge financing from bridge financing source 14. The initial bridge financing tranche is preferably sufficient to purchase options on policies for life settlement policy pool 18 and to pay other necessary expenses of bond issuer 10 in the early stages of the process. It will be understood that the bridge financing can alternatively be obtained against suitable collateral or by appropriate representations such as an underwriter's conditional willingness to purchase the inventive life settlement bond issue, or for stock in the project or by other suitable means. Alternatively, bond issuer 10 may be able to provide the bridge financing from their own resources, perhaps cash from a prior successful issuance of a life settlement bond according to the invention.

In step 34, bond issuer 10, employing the initial tranche of bridge financing, works with policy sources 12 to negotiate the purchase of options on suitable, carefully selected life insurance policies destined for inclusion in life settlement policy pool 18. The optioned life policies are preferably selected, inter alia, to yield benefits, notably death benefits, at a time or times correlating with the debt service requirements of the life settlement bond 18. Such selection can be effected as illustrated by policy screening 17 in FIG. 1, using policy due diligence to eliminate policies of doubtful probity where problems may arise in collecting benefits, and using actuary tables to select policies with appropriate benefit timing expectations.

Once rights in a life insurance policy have been assigned, pledged or otherwise legally transferred or obligated to a third party by the policy owner in return for valuable consideration, the life insurance policy is known as a “life settlement policy” or simply a “life settlement”. Thus, the policies in policy pool 18, having been assigned to bond issuer 10, or to a bond administration trustee, may properly be described as life settlement policies, which term may be used hereinafter and can be understood to include what are known as “viaticals” which are life settlement policies obtained from policyholders having terminal, or life-shortening illnesses.

In step 36, bond issuer 10 uses the policy options to obtain a firm, written commitment from the underwriter to purchase the inventive life settlement bond issue. The commitment is based upon the life settlement collateralization optioned by bond issuer 10 in step 34, and other favorable structural characteristics of the bond, as described herein, which are expected to assure the bond of an attractive rating.

In step 38, the underwriter's commitment, or other suitable collateral is used to obtain a second tranche of bridge financing from bridge financing source 14, completing the bridge financing. The amount of the second tranche is preferably adequate to effect the purchase of the optioned life policies, and to cover other necessary expenses concomitant to issuance of the life settlement bond.

It will be understood the described first and second tranches of bridge financing used to option and purchase the life settlement policies selected for inclusion in life settlement policy pool 18 could be obtained from separate sources or from a single source, bridge finance source 14, possibly in a single agreement or transaction. The single source could, as indicated in FIG. 1, be an independent bridge finance source, source 14, or could optionally be one of the parties to the project, for example the underwriter (not shown in FIG. 1). A particularly convenient arrangement is for the bridge financing to be obtained by bond issuer 10 from a single source and drawn down on an as-needed basis.

In step 40, the second tranche of bridge financing is used to obtain full or necessary rights to the optioned life insurance polices and to effect their assignment to policy pool 18, setting up the bond collateral. All the relevant financial benefits in the policies in life settlement policy pool 18, including in particular death benefits, are formally assigned or obligated to bond fund 20. More particularly, it is envisaged that all rights to any benefits in the selected life insurance policies, including death benefits, will be vested in life settlement policy pool 18.

In step 42, with the collateral represented by life settlement policy pool 18 in place, the life settlement bond is issued, by bond issuer 10. An underwriter can be, and usually is, employed to offer the bond to the appropriate market, for example to institutional investors only, or possibly to the general public, in lots of suitable size, e.g. one million or ten million dollars. Typically, the underwriter sells the bond lots in the issue to bond investors 16, or possibly to a single bond investor 16 such as a pension fund or other institutional investor, and retains unsold lots in inventory. Proceeds from the from the sale of the bond lots received by the underwriter, less the underwriter's commission, e.g. 1.5%, are transmitted to bond issuer 10.

On the day of issue, documents pertaining to life settlement policy pool 18 and any other instruments or property employed as collateral or backing for the life settlement bond put in a lock box by placing them legally and physically in the hands of a trustee entrusted with administering the bond and meeting the obligations of the bond.

In step 44, the proceeds from the sale of the bond lots are used to fulfil bond issuer 10's obligations. Bond proceeds 45 are the investments made by the bond investors 16 amounting to the face value of the bond. The disbursement of funds can be made in any desired, prudent manner that will meet the objectives of the invention, for example, by making the following payments and purchases:

completion of service agreements with professional service providers such as actuaries, legal counsel, financial, medical and insurance advisors and the like, step 46;

servicing and retiring the bridge financing, step 48;

payment of pre-issuance expenses, step 50;

purchase, or completion of purchase, of a bond credit guarantee to cover the risks presented by policyholders outliving their actuarial life expectancy, step 52;

purchase of two guaranteed investment contracts (“GICs”), step 54, as follows:

GIC A to support payment of the premiums on the policies in life settlement policy pool 18;

GIC B to support coupon payments on the bond; and

completion of the purchase of a credit wrap to upgrade the credit rating of the life settlement bond, step 60.

It will be understood that many or all of the facilities paid or purchased in steps 46-60 may have been subject to initial optioning or secural payments made prior to issue of the bond, out of the bridge financing or other sources of seed capital, in order to line up the requisite service or facility. Other possible disbursement scenarios and methods of financing issuance of the life settlement bond, will be apparent to those skilled in the art.

Bond Indenture

Preferably, or necessarily if required by law, practical embodiments of the life settlement bond of the invention comprise a bond indenture, also known as a “bond resolution” or “deed of trust”, which bond indenture is a written document, the latter term including electronic documents, as used herein, and describes the terms of the bond issue. The indenture may describe the form of the bond, the amount of the issue, the property pledged including life settlement policy pool 18, redemption rights, call privileges and the appointment of a trustee to carry out the terms of the indenture. The bond indenture can include suitable covenants defining the roles of the various instruments described herein, including GICs A and B, the bond credit guarantee and the credit wrap.

The invention also includes other equivalent or similar instruments or groups of instruments to the bond indenture that may be known or become known to those skilled in the art and which may be employed to memorialize the essential particulars of the bond.

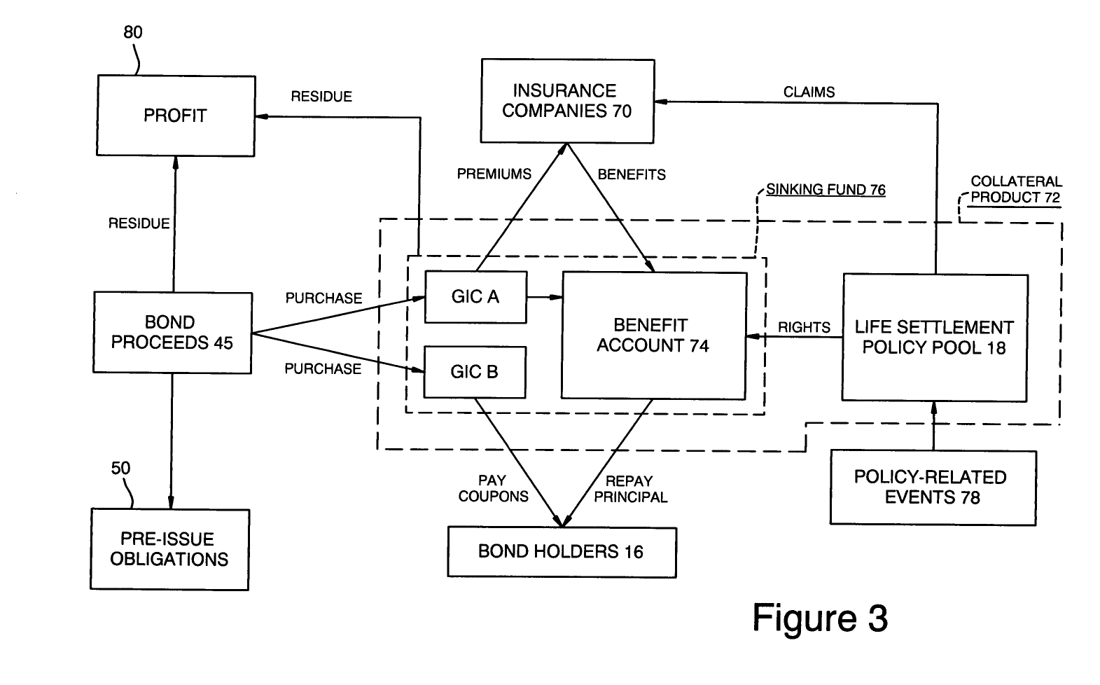

Turning now to FIG. 3, the pattern of cash flow illustrated therein is designed to assure maintenance in force of the life policies in life settlement policy pool 18, payment of the bond coupons and redemption of the bond, all in a timely, efficient and profitable manner.

Referring to FIG. 3, some of the cash flow events here illustrated were described in connection with FIG. 2, notably the use of bond proceeds 45 to purchase GICs A and B and to pay pre-issue obligations, step 50, but the role of these events in the overall picture of the illustrated embodiment of the inventive process is more clearly apparent from FIG. 3.

GICs A and B, described in more detail below, are financial instruments that are purchased from highly rated financial institutions, such as insurance companies, and are structured to provide a regular stream of income that will approximately correspond in timing and amount with the respective obligations they are intended to meet. These obligations are, for GIC A, to pay the premiums on the policies in life settlement policy pool 18, and, for GIC B, to make coupon payments on the bond. The GICs preferably enable each of these respective obligations to be paid largely or, preferably, entirely, from the respective GIC income stream. For example, the GIC income in one year may be from about 75 percent to about 125 percent of the amount of the respective obligation to be satisfied. However, other relationships will also be helpful to the objectives of the invention.

Thus, as is shown in FIG. 3, income from GIC A is used to pay the premiums due on the life insurance policies in life settlement policy pool 18 to the respective insurance companies 70 and income from GIC B is used to make the coupon payments on the bond to bond investors 16. GICs A and B, together with life settlement policy pool 18, can be assembled as a coherent life settlement collateral product 72 operated as a lock box, which has all the ingredients necessary to guarantee the servicing and retirement of the inventive life settlement bond.

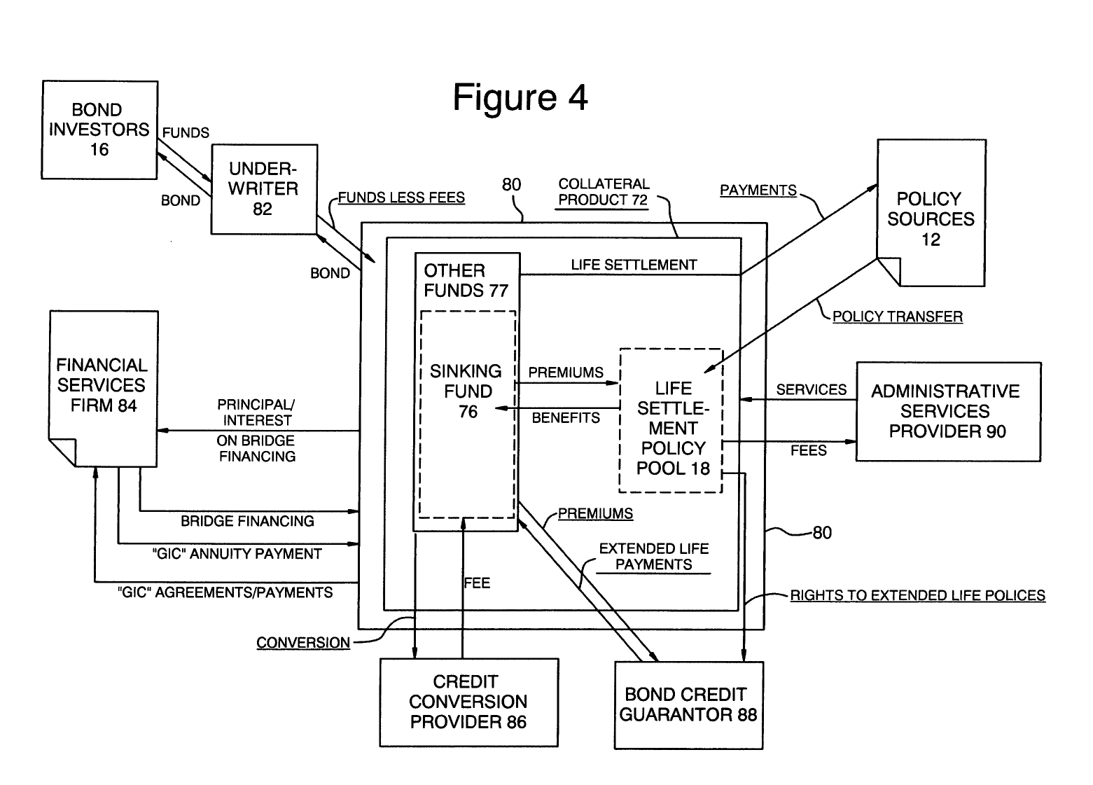

To this end, for example, collateral product 72 can comprise a bond collateral trust administered by an independent, reputable trustee, which trust is formally constituted for the sole purposes of servicing and redeeming the life settlement bond. The various properties can be put into collateral product 72 which places them into the bond collateral trust on the day of issue of the life settlement bond, or at another appropriate time. In addition, collateral product 72 includes a benefit account 74 to receive benefits collected from policies in life settlement policy pool 18. If desired, GICs A and B and benefit account 74 can be constituted as, or be core elements of, a sinking fund 76 which is a trust fund dedicated to the life settlement bond. Collateral product 72 can include one or more accounts additional to sinking fund 76, indicated in FIG. 4 as other funds 77, for managing monies, including funds held on a temporary basis, that are to be held as collateral but are not intended to be dedicated to sinking fund 76.

As relevant policy-related events 78 occur, for example the death of the insured or other maturation of a policy term, the designated policy benefits are claimed from the insurance companies 70 and paid into benefit account 74 where they are held and invested until needed. At term of the life settlement bond, or when the bond is called, the benefit account funds are employed to repay the bond principal to bondholders 16.

Deaths occurring prior to the calculated life expectancy of the insureds will have a favorable financial impact, which may partially offset the cost of a “life extension” bond credit guarantee required to secure timely payment of death benefits on insureds outliving their calculated life expectancy. In the first place, the death benefit can be invested to earn interest until maturity of the bond. Secondly, premiums will no longer be payable. Accordingly, the funds for the respective premium payments received from GIC A can be paid into benefit account 74, as indicated by the arrow in FIG. 3, where they may also earn interest.

After redemption of the life settlement bond by repayment of all principal, and payment of other outstanding obligations associated with the bond, should there be any, residual funds, if any, of the bond proceeds 45 and the sinking fund 76 are retained by bond issuer 10 as profit, step 78. If desired, the profit may accrue as equity to stockholders in bond issuer 10 (FIG. 1), if bond issuer 10 is a stock-issuing entity.

The above-described lock box components, GICs A and B, benefit account 74 and life settlement policy pool 18 provide security that the interest on the life settlement bond will be paid and that the bond itself will be repaid. Furthermore, GICs A and B and life settlement policy pool 18 are structured to provide, at reasonably appropriate times, the revenue streams and capital sums that will make those payments possible.

As illustrated in FIG. 4, collateral product 72 comprises a major component of bond fund 20 (FIG. 1) which may also include other suitable accounts as necessary and convenient for bond issuer 20.

Referring to FIG. 4, many of the structures and processes employed in the somewhat more complex life settlement bond issuing, servicing and redemption method illustrated are substantially the same as, or equivalent to, those shown in FIGS. 1-3, as will be apparent from the description, the commonly used reference numerals, and a comparison of the figures.

In FIG. 4, a frame 80 is employed to schematically depict the role of bond issuer 10 or a bond trustee, neither of whom, or which, is depicted, per se, in this figure, as an interface between collateral product 72 and the outside world. Within frame 80 are shown the investment structures created by bond issuer 10 while around the outside of frame 80 are shown various third parties with whom bond issuer 10 can deal to effect the transactions, to obtain the services and instruments needed to create these investment structures and to issue and service life settlement bond 92.

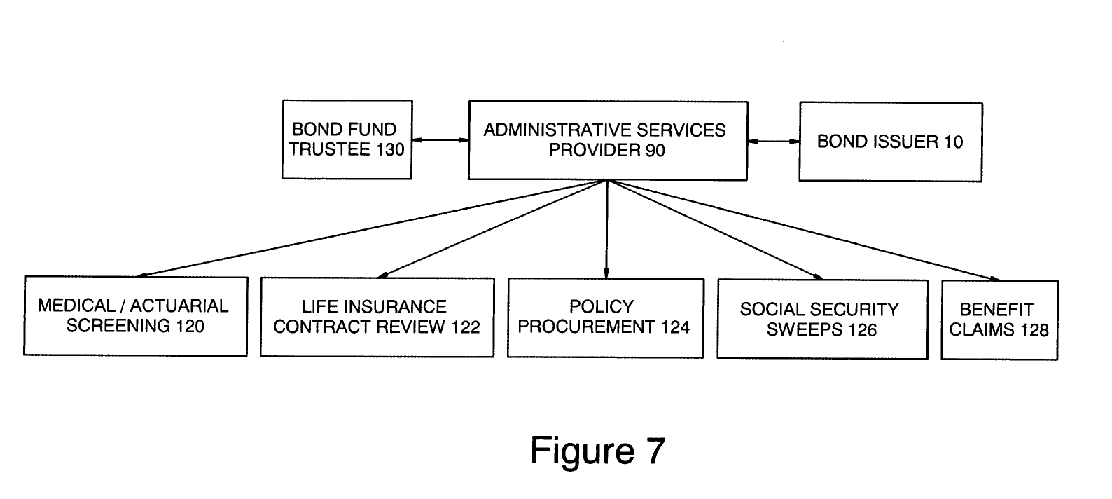

The various third parties shown in FIG. 4 include, in addition to policy sources 12 and bond investors 16, an underwriter 82, a financial services firm 84, a credit conversion provider 86, a bond credit guarantor 88 and an administrative services provider 90. Some additional service providers are shown in FIG. 7.

As is apparent from FIG. 4 and described more fully elsewhere herein, underwriter 82 functions as an intermediary between bond investors 16 and bond issuer 10, acting to distribute or place life settlement bond 92 to bond holders 16 and to remit the investment funds received less the underwriter's fee or commission, to bond issuer 10. Financial services firm 84, which could of course be one or several firms, acts as the bridge financing source 14 shown in FIG. 1, and also provides GICs A and B in return for appropriate payments. Credit conversion provider 86 provides an optional credit wrap to upgrade the bond rating in return for a suitable fee. Bond credit guarantor 88 provides extended life payments in return for lump sum, or annual or semi-annual premium payments. Administrative services provider 90 provides a variety of services in exchange for a fee, as is described in more detail in connection with FIG. 7.

Some of the financial instruments that can be employed in the inventive bond creation and maintenance method are described in more detail in the following paragraphs. Other suitable or equivalent instruments will be apparent to those skilled in the art in light of the disclosure herein. Initially the life settlement bond itself will be described.

Bond Features

The novel life settlement bond or other indenture (if not produced as a bond), of the invention, can have any desired financial features that will enable or assist the life settlement bond to be profitably marketed having regard to prevailing market conditions, including, in particular, prevailing interest rates. Some nonlimiting examples of possible terms to maturity and coupons as well as desirable ratings are described in the following paragraphs. Those of ordinary skill in the art will know or understand other possible terms in light of this disclosure.

The term to maturity of the inventive life settlement bond is preferably relatively short, being, for example, in the range of from about 5 to about 10 years with a term of about 7 years being particularly preferred. It will be understood that, pursuant to custom, bond terms expire on December 31 of their final year, regardless of the month in which the bond issued. Thus, for example, a seven-year bond issuing on Aug. 29, 2003 will mature on Dec. 31, 2010.

At maturity the bond is redeemed meaning that the principal, or face amount of each bond certificate, is repaid to the bond holder by the issuer or their agent. The term is selected according to actuarial considerations as to the timing and probability of receipt of revenues from the life settlement pool. In this respect, the bond term can be selected to facilitate matching of bond debt servicing and liquidation requirements to actuarially forecasted proceeds from the life settlement pool. A term in the range of from about 5 to 10 years is helpful in identifying commercially available policies having expected death benefits within corresponding or relevant periods. One or more examples of this relationship will be more fully described hereinbelow. The inventive life settlement bond can have any desired term, for example from about 2 to about 99 years, preferably from about 5 to about 30 years and more preferably to about 10 years. It is contemplated that the need to service life insurance policies with premium payments will make terms longer than 10 years economically unattractive in most, but not necessarily all, cases. Debt securities with terms less than 5 years are often called “notes” or “bills”.

The coupon of the bond, which is to say, the interest rate payable, can be any desired rate that will make the bond attractive to investors and which will nevertheless be profitable to bond issuer 10. For example, the coupon may be in the range of from about 25 to 500, preferably from about 50 to 200 basis points over the corresponding U.S. Treasury bond yield, each basis point being, as is understood in the art, an interest rate of 1/100th of 1 percent of the principal. As presently envisaged, a coupon range of about 100 to about 150 basis points above the corresponding U.S. Treasury bond yield is considered particularly useful.

By way of specific example, if U.S. Treasury bonds with seven years to maturity are yielding about 2.5 percent, the coupon for the inventive life settlement bond might be chosen to be about 3.75 percent, 125 basis points above the corresponding treasury yield. Treasury rates may fluctuate in the range from about 1 percent and about 7 percent, although other rates have been known. Pursuant to the foregoing considerations, the coupon of the inventive bond may vary from about 1 percent to about 12 percent. However it is contemplated that the coupon will more commonly be in the range of from about 2 to about 7 percent.

As is customary, the rate is selected according to prevailing market rates and the publicly perceived risk investment in the bond entails. Conveniently, the coupon can be expressed as a specifically stated increment above a prevailing market benchmark, most commonly the actual or calculated U.S. Treasury note or bond yield for the corresponding term. Such reference is merely a convenience. In practice, under present U.S. regulations, the bond will have a specific coupon when issued which will be fixed for the life of the bond. However, the invention can employ other desired and legally permitted coupon or interest rate designations including not only fixed rates, but also variable rates or rates related to a variable benchmark such as the prevailing Treasury rate for the term, or the CPI, which is to say the United States consumer-price index. While it is contemplated that the coupon rate should in most cases be selected to be above the benchmark rate, a lower rate could be employed if deemed commercially effective, for example where elements of the invention, such as the benchmark rate, reside or originate outside the United States.

Where a significant proportion, or all, of the life policies in the life settlement pool have payouts that are related to a publicly known, financially related benchmark or barometer, including for example, not only the aforesaid Treasury and CPI rates, but commercial indices such as the Dow Jones or Nasdaq stock market indices, then, with advantage and with legal regulations permitting, the coupon can also be related to the same index or indices. Such relationship can provide an expectation for bond issuer 10 that fluctuations in life policy benefit revenues that become beneficially related to bond service interest expenses.

The bond coupon or interest rate is preferably fixed, having the same value from issue to redemption, but may be variable if desired. The yield may vary according to a schedule or may be linked to a benchmark such as a U.S. Treasury rate. Particularly desirable if a variable interest rate is employed is for the variation to be related to an expected variation or variation in the benefits accruing to the policy pool, or to other financial instruments derived from or dependent upon the policy pool benefits. The pattern of variation of the bond coupon may be determined by bond issuer 10, consistently with relevant regulations, to serve any other purpose useful for project management.

The rating of the bond is determined by an independent commercial agency, for example Standard & Poor's Corporation (referenced “S&P” herein), Moody's Investment Services, Fitch Investor Services and Duff & Phelps. The rating is an opinion on the relative investment merit of the bond which must usually be purchased from the agency by bond issuer 10 who must make a specific request to be rated. The various agencies employ generally similar rating notations ranging from a very risky rating of “C” through “CCC”, “B” and so on to the highest rating of “AAA”. Moody's employs minor modifications of this notation. Knowledge of a rating service's criteria may enable a bond issuer to design their offering to attract a particular rating.

An “investment grade” rating indicates a security may be suitable for purchase by conservative investors because the security offers moderate to low risk. A Moody's rating of Baa or higher, or a rating of BBB or higher by other rating agencies is generally considered to be investment grade. With advantage, the inventive bond is designed to attract an S&P rating of at least “BBB”, preferably at least “A” and more preferably at least “AA”, a particularly high quality rating afforded to few non-governmental debt securities. Some factors affecting the rating are more fully described elsewhere herein. Specific ratings referenced herein are as determined by S&P, unless the context indicates otherwise.

The novel life settlement bond of the invention may be issued in one or more tranches having any desired face value, for example from about $10 mm (“mm” is used herein to reference “million” or “millions”) to about $1 billion or even several billion dollars. However, smaller tranches may be uneconomical or show only a small profit and it is contemplated that relatively large tranches, for example of at least $50 mm and more preferably at least $100 mm will be beneficial. It is furthermore believed that such large tranches will be accepted by the market, provided the inventive life settlement bond is created with a sufficiently attractive combination of features to be competitive. Particularly preferred are tranches in the range of from about $200 mm to about $1 billion, for example $400 mm or $500 mm.

Provided they can be floated without undue difficulty, such larger tranches of $200 mm are beneficial not only for scaling efficiencies, but also because they permit stochastic averaging of high quality policies to be effectively employed to help correlate the cash received from life settlement policy pool 18 into bond fund 20 with the life settlement bond servicing and retirement needs, as is described in more detail hereinbelow. It will be appreciated that the foregoing face values are expressed, as are other dollar values herein, in 2003 dollars, and appropriate adjustments should be made in the future, as will be apparent to those skilled in the art.

If desired, the life settlement bond of the invention may have one or more call options, which is to say the right to call in the bond, according to terms specified in the bond indenture, prior to maturation of the bond term, and redeem it or repay the principal, effectively extinguishing the bond. For example a call option may be specified to come into effect after four or five or six years of a seven year bond term. In one desirable embodiment of the invention, one tranche of the bond has a call option while another tranche of the same bond has no call options. For example, a $200 mm 7-year life settlement bond could be structured in two tranches of $100 mm each one of which has no calls and the other of which is callable at 5 years. In the event that life policy benefits were to accrue at the front end of projections, the one tranche could be called and redeemed.

Financial Structure

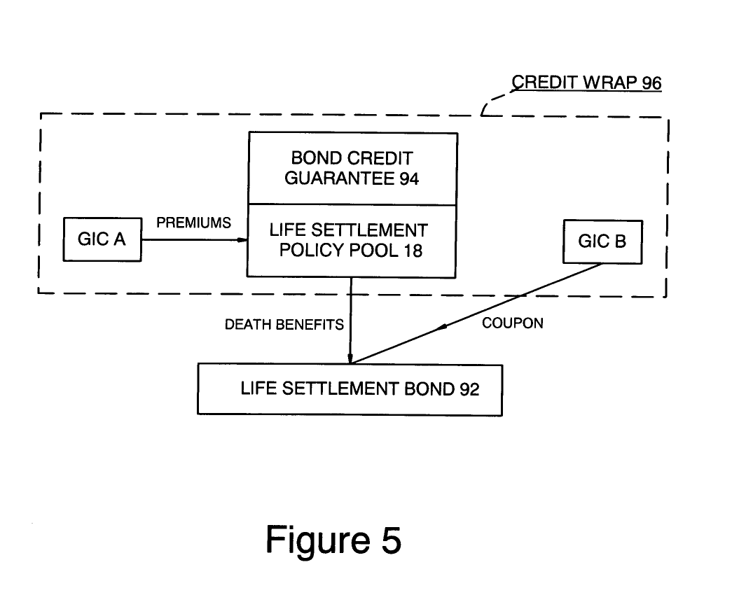

Referring now to the bond financial structure illustrated in FIG. 5, a life settlement bond 92 such as is described herein is collateralized by life settlement policy pool 18 and GICs A and B. GIC A provides income for paying premiums on the life insurance policies in life settlement policy pool 18. GIC B provides income for paying the coupon, the half-yearly or yearly interest payments, on life settlement bond 92. A bond credit guarantee 94 provides timely death benefits for insureds in life settlement policy pool 18 who outlive their calculated life expectancy. Death benefits received from life settlement policy pool 18 and bond credit guarantee 94 provide funds to redeem life settlement bond 92 at term or when called. A credit wrap 96, or bond insurance, can be used to upgrade the rating of life settlement bond 92, if desired.

Guaranteed Investment Contracts

Preferred for employment in the invention to provide one or more streams of regular income payments to meet recurring obligations are, as mentioned above, what are known as “guaranteed investment contracts”, abbreviated to “GICs”. However, other investment vehicles may be employed to provide the desired revenue streams, for example investment indentures, bank strips (the principal and interest components of a bond or the like) future debt obligations and so on. Desirably, such other investment vehicles employed to provide a basis for the cash flows needed to support life settlement bond 92 are of investment grade, preferably of sufficient quality to be ratable BBB or higher by S&P, more preferably A or AA.

A guaranteed investment contract, “GIC”, is a financial instrument purchased from a financial institution, especially highly rated financial institution, which guarantees a repayment of a capital amount or payment of one or more specific amounts on a specific day or days. An example of a GIC is an agreement between an insurance company and a pension fund, municipal or commercial bond issuer or the like, assuring a specific return on capital over the life of the agreement.

A useful feature of the bond issuing, servicing and redemption method of the invention is to service the premiums on life settlement policy pool 18 by purchasing GICs that are matched more or less closely to the anticipated premium payments. For example, GIC A may be matched so that on every day on which a premium payment becomes due, a matching payment is received from GIC A to cover the premium payment. Clearly this is an idealized scenario which may in some cases be approximated quite closely in practice. Various arrangements may be employed. For example the portfolio of GIC A may comprise a number of investment contracts corresponding with the number of policies in life settlement policy pool 18 which may be matched one-to-one to the life settlement policies.

Alternatively, in a case where two or more policies have premiums falling due on the same day, a single GIC may cover the two or more payments. Other useful arrangements will be apparent to those skilled in the art.

In a specific illustrative, but non-limiting example, a 365-day zero coupon GIC for $1 mm is purchased at a discount on prevailing market rates. Being zero coupon, no payments are made during the life of the instrument, but it is settled in full at term. Preferably the GICs are purchased from the highest AA- or AAA-rated (“double-A” or “triple-A” rated) institutions, for example insurance companies, in order to help confer the best possible rating on the life settlement bond 92 of the invention, facilitating its marketing and profitability. By comparison, it may be noted that in the year 2003, major U.S. commercial banks, e.g. Citibank, typically have a single A rating.

Such GICs are not generally available to the public, but must usually be purchased by brokerages or institutional investors, as referenced hereinabove. It is contemplated that implementation of the herein described processes of preparation for issuance of a life settlement bond 92 according to the invention may qualify bond issuer 10 as an institutional investor, for example, by having assets in excess of $10 million.

When purchased from double A- or triple A-rated institutions GICs provide the valuable advantage of a steeper discount curve versus treasury bonds. Other financial institutions may be limited by federal reserve requirements as to the discounts they can offer. In addition, purchase of a GIC as opposed to more publicly available financial instruments may have the advantage of bypassing an underwriting fee which may be as much as 1½%. While a highly rated instrument is desirable, the GICs could however be purchased from a BBB or other less highly rated institution, if desired.

In one example, GIC A comprises a portfolio of investment contracts structured so that the contract maturity dates approximately coincide with the due dates of premiums on the qualified senior life settlements in life settlement policy pool 18.

Comparably, an example of GIC B comprises a portfolio of investment contracts structured so that the contract maturity dates approximately coincide with the due dates of coupon obligations on the bond. It will be understood that precise coincidence of dates will not generally be possible and that maturity dates that are from about one day to one month within or preferably prior to the respective due dates will usually be satisfactory for the purposes of the invention.

Bond Credit Guarantee 94

Another optional but preferred feature is the purchase of a bond credit guarantee wherein an insurance carrier guarantees that it will purchase or loan funds on policies, at full face value, for insureds that live beyond their actuarially opined life expectancy. The term “life expectancy”, as it relates to insured parties is understood by those skilled in the art and is usually understood to be a calculated, mean age of death for members of a cohort of individuals with certain characteristics in common with the insured party, for example year of birth, sex, race, life style characteristic, disease condition, or the like. This being the case, fifty percent of the deaths in the cohort will be expected to occur after the point of calculated life expectancy. In practice, because the life expectancies are evaluated in one year time slices, the calculated proportion of a cohort outliving the life expectancy will be somewhat less than fifty percent. Even where life settlement policy pool 18 contains many policies whose insureds have life expectancies substantially less than the term of the bond, there is nevertheless a significant probability that some members of the cohort will outlive the bond term. Thus, death benefits will not mature on their policies and may not be available for redeeming the bond when due. Unless otherwise apparent from the context, specific life expectancies referenced herein are calculated from the date of issue of the bond.

To solve this problem and help ensure that adequate funds will be available to redeem the bond when called, various possible bond credit guarantee contracts can be employed, as will be apparent to those skilled in the art. In one illustrative example of such a contract, payment is made to bond issuer 10 (or more likely to the bond trustee) at the end of the year of life expectancy assigned to the policy if death does not occur prior to the projected life expectancy, and if insufficient funds exist to pay bond obligations. The amount is preferably the face value of the policy, and optionally additionally includes return of any premiums or other fees paid by bond issuer 10 to the insurance carrier.

Premiums for the bond credit guarantee can be paid with any desired and agreed frequency, for example annually, in an amount agreed with the carrier based upon relevant ratings and appropriate actuarial assumptions. Such premiums can be paid annually from the initiation of coverage, at issuance of the bond, or a short time beforehand, until the death of the insured or the maturity of the bond, whichever comes first. Upon the death of the insured prior to expiry of the bond term, premium payments for the credit guarantee (as well as the premium for the death benefit) cease, and the death benefit is obtained from the insurer. If the insured survives the bond maturity date, then, at term, bond issuer 10 collects the value of the death benefit from the bond credit guarantor either as a loan until the respective life policy matures or in return for assignment of the life policy, according to the bond credit guarantee contract.

In another, hypothetical example, when a seven-year bond, backed by a pool of 300 life settlement policies matures, 45 policies having an average death benefit of $1 million are still outstanding as a result of their insureds having survived past their respective life expectancies. All rights to the policies are assigned to the bond credit guarantor who pays $45 million to bond issuer 10, or more probably to the bond trustee, topping up sinking fund 76 and enabling full redemption of the bond. The specialized bond credit guarantee described in the foregoing paragraphs may be regarded as a form of bond insurance.

Suitable carriers for such bond credit guarantees for a bond issued in the United States include MBIA, Inc., Armonk N.Y., GE Re, Munich Re and other reinsurance or off-shore insurance providers capable of handling such transactions.

Credit Conversion

If desired a suitable credit structure can be designed to create an objective credit rating for the bond offering. One example of such a credit structure is a credit default swap, wherein credit conversion provider 86, who is preferably a rated name insurer or other financial institution, assumes the bond default risk, converts the rating of an unknown bond issuer to the more favorable rating of the name insurer. Using terms of art, pursuant to this optional embodiment of the invention, a full-rating credit wrap is provided to convert a “shadow” rating into a formal rating. An objective of such a credit conversion is to assure the performance of the life settlement bond 92 of the invention with respect to any and all of the bond payment obligations. Such a credit wrap may also be regarded as another form of bond insurance.

Life Settlement Policy Pool 18

A particularly useful feature of the invention is the collateralization of the life settlement bond 92 of the invention with a pool of life insurance policies having a unique combination of characteristics such as those described for life settlement policy pool 18.

To assemble life settlement policy pool 18, bond issuer 10 or their representative or intermediary in the bond issuing process, can acquire individual policies by making a cash payment to the policyholder in exchange for ownership or other forms of transferable interest in the insurance policy. Once ownership or other suitable interest in the policy is acquired, bond issuer 10, or a bond trustee or an associated party duly authorized by either, is designated as beneficiary on the acquired policies in order to receive future death benefits, and any other available benefits, upon the death of the insured. In most, if not all cases, the insured, who may or may not be the original policyholder, remains the same throughout the transaction and thereafter.

Premiums are paid to satisfy the policy contracts and keep the acquired policies in force. The premiums can be funded, as described above, by the income stream from GIC A, or another suitable investment indenture or instrument. If a premium is not paid, the respective policy contract may lapse and the investment in the acquisition of the policy would be lost. Upon the death of the insured the designated beneficiary receives the death benefit proceeds from the insurer.

Preferably, the pool of life insurance policies is pledged by bond issuer 10 against redemption of the face value of the bond. It will be understood that suitable collateralization may be effected by employing multiple pools of life insurance policies, which pools may or may not be interrelated or interdependent. For example, one policy pool may be pledged against one tranche of the life settlement bond 92 of the invention and another policy pool may be pledged against another tranche. Desirably, if one policy pool, or group of polices in the life settlement policy pool 18 has more uncertainty in the timing of expected benefits than another, that policy pool or group can be employed to collateralize a callable tranche of the bond.

Desirably, the total market value, or cash liquidation value, of all the life insurance policies in life settlement policy pool 18 at the time of assembly of the pool or on issuance of the bond is at least equal to, and preferably exceeds the face value of the bond. Preferably, the margin of excess is at least 2 percent, more preferably at least 5 percent and still more preferably at least 8 percent. A margin of excess of about 10 percent is believed particularly suitable. For example, the pool value at issuance of the bond may be about 110 percent of the face value of the bond. The margin of excess can be varied according to the quality of the pool and may be as high as 20, 25 or even 30 percent, at issuance, if desired.

Life settlement policy pool 18 can comprise any desired number of life insurance policies. For stochastic and other purposes it is preferred that the number of policies be at least about 50, more preferably at least about 100 and still more preferably at least about 200. In one preferred embodiment of the invention life settlement policy pool 18 has at least about 220 policies and in another embodiment, at least about 320 policies. While there is no particular upper limit, it is contemplated that preferred embodiments of the invention will employ life settlement policy pools 18 having not more than about 1,000 policies, possibly not more than about 600 policies. Larger pools are desirable for the actuarial smoothing they offer.

In order to ensure that life settlement policy pool 18 constitutes high quality collateral helping to make the life settlement bond 92 worthy of a good rating by a suitable rating agency, available policies on the market are subjected to a stringent qualification process in order to be included in the pool. As explained in more detail below, suitable policy qualification procedures include medical analysis, application of suitable actuarial data, and legal compliance review for contractual integrity.

Preferably, life settlement policy pool 18, which provides the primary capital backing the inventive bond, comprises a pool composed primarily of universal and/or whole life policies. More particularly, in one embodiment of the invention life settlement policy pool 18 consists entirely, or at least 90 percent of senior life settlement insurance policies that preferably are universal and/or whole life policies.

As used herein, “senior life” refers to a life insurance policy that covers an insured whose actuarially opined life expectancy ranges from two to eight years. Generally such an insured has attained an age of sixty years, or greater, and has a health problem adverse to longevity that manifested itself after the policy was issued. It will be understood that senior life policies may be advantageous for the particular embodiments of the invention here described but that other non-senior policies may be used in other embodiments of the invention.

As used herein, the terms “settlement” or “life settlement” refer to a life insurance policy where the insurable interest and/or the beneficiary interest have been conveyed to a third party, notably, in the present invention, bond issuer 10.

“Qualified” references a policy that meets the standards described herein that a senior life settlement insurance policy should preferably meet as a condition for inclusion in life settlement policy pool 18.

It is estimated in year 2003 that approximately $5 billion to $6 billion worth of life policies are available for purchase by a third party in the United States. Depending upon the stringency of the model criteria employed it is believed that about 15%-20% of this market could be suitable for inclusion in life settlement policy pool 18. However, more detailed examination of available policies could indicate that many are not suitable.

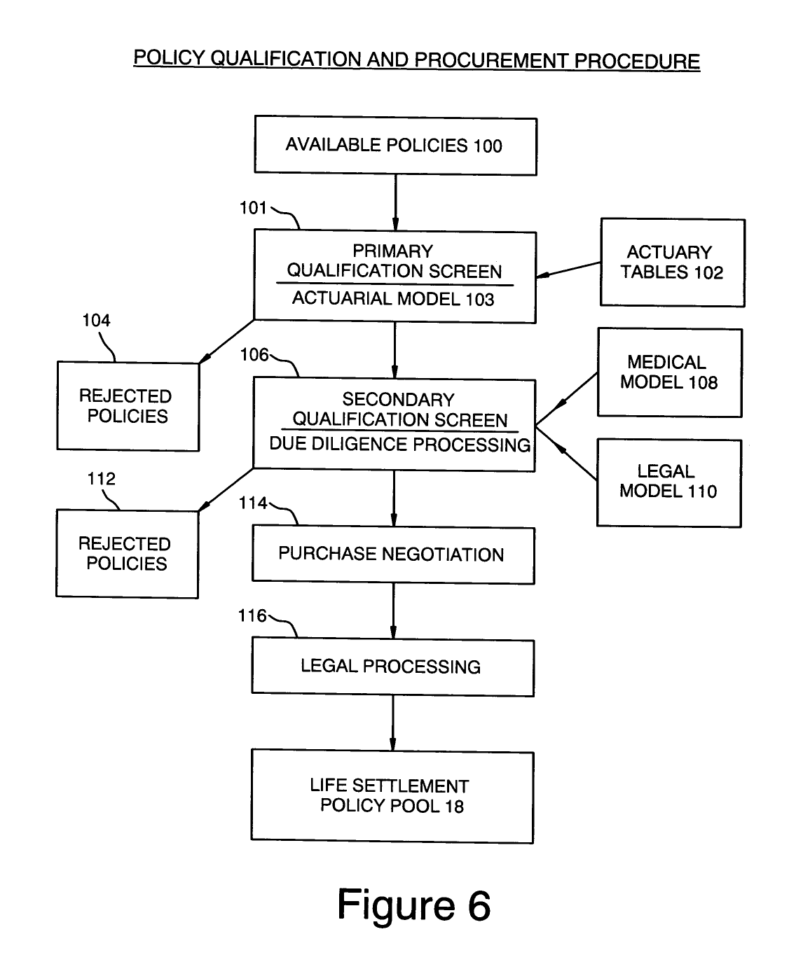

Referring now to FIG. 6, the policy qualification and procurement procedure shown illustrates but one example of a procedure that may be used to build a high quality, effective, life settlement policy pool 18 by carefully selecting from available policies 100 a limited number of policies to be procured and included in life settlement policy pool 18.

The invention provides, for the first time, clearly defined criteria for pre-screening and selecting life insurance policies for inclusion in life settlement policy pool 18. These criteria are described in more detail in the following paragraphs.

Available senior life policies 100 may be located from a variety of sources including commercial providers, some of which may be found through the Viatical and Life Settlement Association of America or might be located by direct solicitation of the public at large.

Available policies 100 are subjected to a primary qualification screen, step 101, employing actuary tables 102 and an actuarial model 103 to determine whether they meet specified desired actuarial parameters regarding one or more, preferably all, of the following characteristics: the insured's age and life expectancy; medical condition of the insured; age of the policy; face and cash surrender values of the policy; the type of the policy; and the term of the policy. Policies not meeting the actuarial parameters are rejected, step 104. The actuarial model can include a wide range of additional parameters selected to define policies suitable for inclusion in life settlement policy pool 18.

Preferred actuarial models also include a desirable death benefit program structured to yield adequate benefits shortly before repayment of bond principal is planned. Suitable actuarial models and examples of possible parameters are described in more detail hereinbelow.

Actuarially selected policies passing primary screen step 101 may promise to meet desired financial and timing criteria for the purposes of the invention but some or all of the selected policies may fail to deliver the expected death or other benefits owing to a variety of nonactuarial factors including legal problems such as defects in the title or policy misrepresentations that may jeopardize payment of benefits, and medical problems such as misdescription or misunderstanding of the medical condition of the insured or miscalculation of the impact of the true medical condition on the insured's life expectancy, and other comparable factors.

With a view to eliminating policies having such problems from the selection procedure, the actuarially selected policies are passed through a secondary qualification screen step 106 where they are subject to due diligence processing. The due diligence processing can employ a medical model 108 and a legal model 110 designed to exclude policies that are will fail to meet the objectives of the invention for medical or legal reasons respectively. Suitable embodiments of these models are also further described in more detail hereinbelow.

Policies not meeting the criteria of medical model 108 and legal model 110 are preferably rejected, step 112.

Policies passing the due diligence scrutiny of the secondary qualification screen are then subject to a purchase negotiation, step 114. If a satisfactory price is reached in step 114, legal processing, step 116, is effected to assign the insurer's and beneficiary's rights to life settlement policy pool 18. If desired, legal processing 116 can also include provision of a legal opinion from reputable counsel as to the legal probity of the policy, obtained individually for each selected policy.

Actuarial, Medical and Legal Models 103, 108 and 110

To applicant's knowledge and belief, prior to the present invention, suitable actuarial research findings that would be adequate to serve as a guide in assembling preferred embodiments of life settlement policy pool 18 did not exist prior to the present invention. Nor to applicant's knowledge and belief were there available suitable medical screening protocols correlated with these actuarial findings to facilitate construction of such preferred embodiments of life settlement policy pool 18. Accordingly, the novel actuarial model 103 and the interrelated medical and legal models 108 and 110 described in more detail in the following paragraphs have been devised to help assemble an effective, high quality life settlement policy pool 18 capable of serving as collateral for an investment grade capital market product.

One suitable actuarial model 103 for use in the practice of the invention includes one or more filters for: the financial rating of the insurer of the policy; type of policy; the age of the insured; actuarially opined life expectancy of the insured; and the policy face value.

Preferably, actuarial model 103 includes filters for all of the foregoing criteria and each policy is tested against each criterion.

Preferably, the financial rating of the insurer of the policy is at least “BBB”, more preferably “A” or better referring to ratings such as those provided by Standard & Poor's where “AAA” is the highest possible rating. Such an insurer rating criterion may comprise a first level of screening for candidacy for purchase of a policy for life settlement policy pool 18.

In general, the policy may be of any conventional life insurance type that provides a death benefit, including universal life, whole life, variable life, and so on. Generally the face value of the policy will indicate the value of the death benefit. Preferably, no second-to-die policies are included in life settlement policy pool 18.

If desired, the actuarial model can prioritize available policies according to type to assist in determining their eligibility for purchase. For example universal life policies may be preferred over other types of policies because they have a built in investment for the owner.

Also, in this example, more preferred are universal policies that have not become modified endowment contracts (“MEC”) while universal policies, with or without a surrender period are still preferred to other types of policy. A policy may become a modified endowment contract when the amount of premiums paid into the policy results in a tax-deferred cash value buildup which is considered too great relative to the death benefit. After universal life, whole life is preferred over term life insurance with a term life policy being acceptable provided it has a guaranteed maximum premium of less than a certain percentage of face value, for example not more than about 6%, preferably not more than about 4% of face value.

The policyholder, being the original owner or holder of the life insurance policy, may be any real person or entity legally entitled to hold a life insurance policy of interest for purchase by or on behalf of bond issuer 10, and may be the insured, a spouse or close family member of the insured, a corporate sole proprietorship, a family corporation or other closely held corporation or a partnership legally constituted as a property-owning entity. Also included are key person life insurance that may have been issued to a corporation or partnership. While it is contemplated that one or more policyholders in the pool could be a publicly held corporation, for example an employer of one or more insureds in the life settlement policy pool 18, it is anticipated that in preferred embodiments of the invention, at least 50 percent and preferably at least 90 percent of the policies in life settlement policy pool 18 will have been issued to individuals or non-publicly held corporations or other large institutions. It will be understood that individuals or entities other than the original policyholder may hold or own policies of interest for purchase, acting as intermediaries.

The original policy holding ownership of the policies in life settlement policy pool 18 is preferably heterogenous, comprising many individual or corporate owners. In particular it is contemplated that more homogeneously owned pools, for example those of single institutional owners of employee or customer life insurance, will not generally meet the qualification criteria described herein for inclusion in life settlement policy pool 18.

Also in general, older policyholders will be preferred, for example age 50 or older, preferably age 65 or older. To this end, the average age of the insureds in life settlement policy pool 18 at the time of issuance of the life settlement bond of the invention may be at least 65, preferably at least 70. However, younger policyholders satisfactorily meeting other criteria may be employed if desired, for example, policyholders aged at least 35.

Depending upon the bond term, the actuarially opined life expectancy of the insured can range from about 1 to about 30 years, preferably from about 2 to about 8 years and still more preferably from about 4 to about 7 years. The latter range will generally exclude viaticals which typically have a life expectancy of less than 3 years. The life expectancy is desirably based on new or current medical evaluations.

The policy face value, which will usually equate with the death benefit, can have any desired value for example in the range of from about $100,000 to about $10 million. However a face value in the range of from about $250,000 to about $5 million is preferred. Lower value policies may be uneconomic to process while higher value policies may unbalance desirable stochastic averaging characteristics of life settlement policy pool 18.

Desirably, policies selected are subject to premiums payable at least as frequently as annually. However, what are known as “single premium policies” wherein only an initial premium is payable, can be included, if desired. Preferably however, such single premium policies, if employed constitute no more than 10% of the value of life settlement policy pool 18, by face value.

Some other policy characteristics that may desirably be evaluated for the purchase include:

that the medical condition of the insured has deteriorated since the policy was issued in such a way as to adversely impact longevity;

that the policy is a rated policy rated for a higher risk and having a rating percentage of at least 200%, preferably at least 400% of the standard cost of insurance rate attributable to such a policy;

that the time of purchase be preferably within the period of surrender charges; and

that the policy features include: a “flexible premium”, automatic loan provision to pay premiums, an option to change the face amount, an option to change the death benefit and an optional, long-surrender charge period.

Other possible policy options and features that will be helpful to the objectives of the invention as will be apparent to those skilled in the art and may be included. In one useful embodiment of the invention, the actuarial model includes all the foregoing actuarially related filters.

Preferably life settlement policy pool 18 has policy distribution features designed to correlate life settlement policy pool 18 with the collateral requirements of the bond. For example, a desired proportion of the pool, for example two-thirds of the policies selected can be selected each to have a face value falling within a desired range for example from about $200,000 to about $10 million preferably from about $750,000 to about $1.5 million. Also preferred, is an average policy face amount of about $1.2 million, or within about 15 percent of $1.2 million.

While the policies might all be selected to have maturities in the last year of the bond term, or close thereto, it is preferred that, to help manage the risks without undue expense the policies, preferably 220 or more in number, be divided into a number of cohorts, for example from two to five cohorts, of policies on insureds, having different life expectancies as between one cohort and another. The different life expectancies can be respective ones of a plurality of different years generally in the middle or the latter part of the bond term, i.e. preferably, although not necessarily in the first one-third of the bond term, for example in the fourth, fifth and sixth years of a seven-year bond. The cohorts can be divided into approximately equal groups by face value of the life insurance. For example each cohort proportion can be within about 30 percent of an equal proportion of the total face value. Illustratively, if there are four cohorts, each may comprise from about 18 to about 33 percent of the total face value of the life insurance policies in life settlement policy pool 18.

To the extent that available policies permit relatively free selection, it will be understood, pursuant to the invention, that policies on insureds with life expectancies occurring early in the bond term will be relatively expensive, while those occurring late in the bond term have a higher probability of the insured outliving the bond term and require more premiums to be paid.

The year in which the average life expectancy of all insureds in life settlement policy pool 18 expires is desirably no later than the final year of the bond term. The bond term may be assumed to expire on the thirty-first day of December of its final year. Preferably, the average life expectancy expiry year is at least one year prior to the final year of the bond term, more preferably at least two years prior to the final year of the bond term. The degree to which the average life expectancy expiry year can be controlled to precede the final year of the bond term will depend in part upon the duration of the bond term. Such selection of the average life expectancy in relation to the bond term is expected to increase the number of deaths occurring prior to maturation of the bond and to reduce the cost of a life extension bond credit guarantee.

An example of such a model for a life settlement bond 92, being a bond having a seven year term, is that of three cohorts, as follows: one cohort having policies totaling about 35% of the total pool policy value, with a four-year life expectancy; another cohort totaling about 30% with a five-year life expectancy; and a third cohort totaling about 35% with a six-year life expectancy. Preferably, the maximum aggregate face value in the six-year life expectancy cohort is not more than about 30% of the total pool value policies, for example not more than about $66 mm for a $220 mm pool used to collateralize a $200 mm life settlement bond 92.

It will be understood that the numbers defining the pool cohorts are quite approximate, being capable of significant variation while still fulfilling the objects of the invention as described herein. To these ends it will be understood that, in practicing the invention, it is desirable to maximize expectation and value of the death benefits to be received within the term of the bond, while minimizing the purchase cost which may be expected to vary inversely with the life expectancy of the insured.

A further criterion that actuarial model 103 may employ is a limit on the premium payable on the pool. Such a premium limit may be expressed by requiring that the total premiums payable, or average premium, in a or any future year not exceed a specified percentage of the respective total or average face value of life settlement policy pool 18. The specified percentage can be any desired percentage and should be less than about 10%, preferably less than about 6% for example about 4% or even less. Thus, if some policies having relatively higher premiums are accepted as being otherwise attractive candidates for life settlement policy pool 18, then one or more subsequently selected policies in the pool should have a relatively lower premium to adjust the average.

Traditionally, for determination of life expectancies and calculation of premiums on life policies, the U.S. life insurance industry has, prior to the present invention, employed mortality tables based on 1980 reported data for mortalities to age 65 along with conservative extrapolations of these data for subsequent mortalities. Naturally, such archaic and incomplete data generally understate present-day life expectancies which have increased significantly, especially for older cohorts. Accordingly, premiums are determined conservatively, which is to say they tend to be higher than would be the case were data indicating greater life expectancies relied upon, which may be satisfactory for the objectives of a life insurance company issuing life policies.

However, some of the objectives of the present invention are different from those of an insurance company so that the traditional insurance company approach to life expectancy is not appropriate. For example, in creating life settlement policy pool 18, pursuant to the invention, it is usually desirable to optimize the probability and amount of the death benefits to be received whereas an insurance company's interest is in deferring or minimizing death benefits which they must pay.

Accordingly, in some preferred embodiments the present invention employs more current mortality tables than 1980 and preferably tables that are complete or are based upon actual mortality data for cohorts aged over 65 years. For example, 1984 or 1994 tables can be used. Such tables, which may be variously described as “life expectancy”, “mortality” or “actuary” tables or data, are available from a variety of sources. One source is the United States Government's Center for Disease Control (“CDC”) publishes a number of life expectancy data reports that may be employed in the practice of the present invention, including the National Vital Statistics Reports, Vol. 51, No. 3, Dec. 19, 2002, see for example “Table B. Number of survivors by age, out of 100,000 born alive, by race and sex: United States, 2000” (page 3) and “Table 12. Estimated life expectancy at birth in years, by race and sex: Death-registration States, 1900-28, and United States, 1929-2000” (pages 37-38).

Other useful sources of suitable life expectancy and other data tables useful for the practice of the invention herein include actuarial consultants such as Milliman USA, Seattle, Wash. It is generally desirable for the purposes of the invention to have the most meaningful life expectancy data available to assist in compiling life settlement policy pool 18, which is to say that data which will provide the most accurate predictions of the timing of an insured's death.

Policies or insureds having characteristics lying outside the actuarial criteria included in actuarial model 103 are considered to be not good candidates for purchase and are preferably rejected, step 104.

Following the foregoing actuarial model and other guidelines described herein, one skilled in the art can for the first time provide an actuarial basis that will yield payments appropriate for collateralizing or backing a bond issue such as the life settlement bond 92 of the invention, wherein the bond is defined as having a number of years to maturity of from about 5 to about 10 years, or other suitable period. The present invention includes such a novel actuarial basis and a life settlement policy pool 18 employing such an actuarial basis as well as any capital market product that relies upon a novel life settlement policy pool 18 structured as described herein.

One suitable medical model 108 for use in the practice of the invention includes one or more medically related filters for: reviewing the insured's medical record; obtaining an independent opinion as to the medical condition of the insured; and verifying that the medical condition of the insured is consistent with the stated life expectancy.

Desirably, medical model 108 can call for the insured's medical file to be obtained from their physician. The medical file can be used to obtain a medically based mortality profile from a mortality profile provider, preferably on behalf of bond issuer 10 at bond issuer 10's expense. The mortality profile desirably takes into account the latest available longevity-related condition information and is preferably based upon reasonably current, pertinent mortality data, as is known to those skilled in the art. Such a condition-specific data mortality analysis can be obtained from a commercial provider, such for example as American Viatical, LLC, Indiana. Preferably, such a medical mortality profile is obtained within one year or less, more preferably within six months or less and still more preferably within three months of the date of issue of the bond.

In addition, medical model 108 desirably can also include a historical insured condition review for life expectancy implications wherein the insured's current medical condition is compared with a historical condition, for example their medical condition at the time of issuance of the life policy or at a pertinent time thereafter. Specifically, the object of the historical insured condition review is to determine the presence of a new condition, not considered in formulating the original policy which would adversely impact the life expectancy of the insured. Policies on such insureds are desirable policies to include in life settlement policy pool 18 provided they meet the other criteria described herein.

In one useful embodiment of the invention, the medical model includes all the foregoing medically related filters. The mortality profile and any other relevant medical information can, once the requirements of the medical model have been satisfied, be passed to legal for review.

One suitable legal model 110 for use in the practice of the invention includes one or more filters for: transferability of the insurable interest and beneficial interest; capacity of the owner and/or beneficiary; applicability of state laws impacting transferability; absence of policy encumbrances such as loans or assignments; willingness of the owner of the policy, the beneficiary of the policy and any other person who may claim an interest in the policy to execute:

(a) consent to procure medical information pertaining to the insured;

(b) consent to procure information regarding the structure, terms and specifications of the policy;

(c) consent to transfer ownership of the policy;

(d) consent to transfer beneficial interest in the policy; and

(e) a request to their insurer for an up-to-date in-force illustration showing the performance of the policy over time

and to provide convincing evidence of identity, including social security number.

An in-force illustration is preferably run for the remaining term of the policy. The in-force illustration is a legal instrument which specifies the premium obligation which, if paid timely, will maintain the policy in force. Preferably, the in-force illustration is run for each option which is available to the policy holder or beneficiary including level premium payments and level death benefit. In another useful embodiment of the invention, the legal model includes all the foregoing legally related filters.

A still further useful embodiment of the invention includes all the above-described, actuarial, medical and legal filters to yield a high quality pool 18 of stringently scrutinized life settlement policies uniquely adapted to provide an effective means for funding repayment of the life settlement bond 92 of the invention and to promote a high rating for the bond, or to otherwise produce a valuable capital markets product.

Policies or insureds having characteristics lying outside the medical or legal criteria are not candidates for purchase and are rejected, step 104.

A fictitious example of a possible policy eligible for inclusion in life settlement policy pool 18 is an 81-year-old woman, recently widowed and in poor health with colon cancer which is in remission but which has metastasized to the liver, holding a $1 million policy on which she has a $40,000 premium. With the death of her husband she can no longer afford the premium and is interested in surrendering and liquidating the policy for cash. A typical cash value for the surrender may be about $128,000 less an early surrender penalty of $60,000 giving a net value to the policy holder of $68,000.

While it is preferred that eligible policies be free of debt, liens or other encumbrances, it is possible that policies encumbered with debt yet which nevertheless promise to yield a significant net death benefit could be included.

Legal processing step 116 can include legal counsel's reviewing the policy documents and providing an opinion as to whether they meet the specified requirements for inclusion in life settlement policy pool 18. Legal counsel's review of each policy desirably includes determinations that:

no language in the policy prohibits conveyance of insurable interest or beneficial interest;

that the consent forms are in order;

that there is compliance with applicable state and federal laws;

that the insured's particulars fit the actuarial model, particularly with regard to age and the mortality profile;

that the affidavit of the disinterested third party is in order (see Example 1, below);

that the premium structure is workable, in order and agreed to with the insurance carrier; and

that the insurance carrier's financial rating fits the actuarial model.

Procedures for implementing the policy qualification and procurement method of the invention will be apparent to those of ordinary skill in the art in light of the disclosure herein and in light of the following non-limiting Example 1 which is provided for illustrative purposes.

### EXAMPLE 1

### Purchase of a Senior Life Settlement Policy

In one pre-closing procedure, bond issuer 10 or their agent or employee determine and present a bid to a procuring cause representing an insurable interest holding a policy having been identified as meeting the criteria of actuarial model 103 for inclusion in life settlement policy pool 18 and awaits notification as to award. If bond issuer 10 is the successful bidder, an affidavit is obtained from a party known to the insurable interest and who has no interest in the transaction, attesting that the insurable interest enters into the transaction to convey the policy to bond issuer 10, of their own free will.

In an alternative pre-closing procedure, if a procuring cause to the policy holder, offers a policy to bond issuer 10, or their agent or employee, bond issuer 10 presents a bid to the insurable interest, negotiates the price of settlement, if necessary, and then after successful completion of the negotiation obtains a free-will affidavit as before.

The policy and affidavit of the disinterested third party are submitted to legal counsel for review prior to inclusion in a package of closing documents. If legal counsel's review results in a favorable opinion letter, preparations are made to close the transaction. Otherwise the policy is rejected and the transaction is aborted. A final premium structure is then negotiated with the insurance carrier, if necessary.

Closing documents are prepared and submitted to legal counsel for review and a closing is scheduled. At the transaction close there is an exchange of executed documents for funds. Copies of pertinent documents are forwarded to the insurance carrier who provides evidence of conveyance of the insurable interest to bond issuer 10, or the bond issuer's designee.

Referring now to FIG. 7, as referenced above, the various administrative and management functions associated with the issuance and maintenance of life settlement bond 92 can be carried out by administrative services provider 90 who may be an individual, firm or corporation or a number of individuals, firms or corporations. Administrative services provider 90 may employ, or subcontract, suitable professional firms or individuals, as appropriate. For example legal screening and other functions can be effected by a legal services provider, preferably a law firm that is well-recognized in the financial field.

More specifically, administrative services provider 90 can administer or manage medical/actuarial screening 120, life insurance contract review 122, policy procurement 124, social security sweeps 126 to monitor for registrations of death, and benefit claims 128.

The functions of medical/actuarial screening 120 are largely as described in connection with of FIG. 6 (steps 101 and 106), as are the functions of life insurance contract review 122 and policy procurement 124.

Social security sweeps 126 can be run at regular intervals, e.g. weekly, monthly or quarterly intervals, to sweep state records, for example, by interrogating state databases of death registrations, by social security number, to detect reports of deaths of any insured in life settlement policy pool 18. Such sweeps can be performed by a specialist service. Typically, although not necessarily, a list of social security numbers for each of the insureds in life settlement policy pool 18 is electronically checked against death registrations in each state. It will be understood that sweeps 126 are only one possible means of monitoring the deaths of insureds in life settlement policy pool 18 and that other suitable monitoring means may be employed. As an alternative, a family member, professional advisor or other individual closely associated with the insured may be given a financial incentive to notify administrative services provider 90 of the death of the insured. However, the sweeps process, or an equivalent thereof is contemplated as being more reliable.

Once the fact of an insured's death has been detected, via social security sweeps or other suitable means, administrative services provider 90 initiates a process of death benefit claims 128 to obtain from the respective insurance company 70 the death benefit due. Administrative services provider 90 also works with a bond fund trustee 130, advising him or her regarding investment of funds in the bond trust, and with bond issuer 10 to interchange funds, documents, instruments and information as required by the products and processes described herein.

Administrative services provider 90, working with bond trustee 130, can assist in, or supervise, redemption of life settlement bond 90 at the end of the bond term by repayment of bond investor(s) 16 with funds from death benefits, bond credit guarantees or otherwise as described herein. Once the bond requirements are satisfied and all related expenses paid, administrative services provider 90 can remit any residue to bond issuer 10, or their agent, as profit. Such profit may be distributed to stockholders in bond issuer 10 if bond issuer 10 is a stock issuing entity.

According to one useful embodiment of the invention, bond issuer 10 is an entity newly created for the purpose of issuing life settlement bond 92, and is managed so as to be entirely free of debt at the date of issuance of life settlement bond 92.

If desired, with a view to protecting bond issuer 10 from disputes, litigation or other liabilities, a corporate or other limited liability administrative entity can be employed to perform the services of administrative services provider 90. The administrative entity can be contractually sold by bond issuer 10, or beneficial interest holders in bond holder 10, to an individual or individuals who will act as CEO or other official of the administrative entity. The sale can be effected for a nominal amount, if desired, and the contract can include tight severability provisions enabling the contract to be readily or automatically terminated by bond holder 10 in the event of specified breaches such as malfeasance or nonperformance of defined administrative duties by the respective individual or individuals. In the event of such breaches, the contract can be quickly terminated. A new administrative entity can then be created and contractually sold to a new administrator.

### EXAMPLE 2

### A Life Settlement Bond

A life settlement bond of face value $200 mm is issued with a term of 7 years, as two notes, Note A and Note B for $100 mm each. Note A is callable after 60 months and Note B is not callable. The interest rate is selected to be 125 points over appropriate term treasuries. Seven GICs, GIC portfolio A, in the form of zero discount notes are purchased for a total of $54 million with terms such as to yield the coupon payments required to service the bond in each of the bond's seven years.

A pool of about 185 life settlement policies of average face value about $1.2 mm each, with insureds of average age 71, each having a deteriorated life-determining medical condition, is assembled as collateral, total face value $220 mm, at a cost of about $46 mm. A second portfolio of 185 GICs, one for each life policy, GIC portfolio A, also in the form of zero discount bonds is purchased for a total cost of about $38 mm. The bond is distributed by an underwriter who receives 2.5% commission, about $5 mm. A bond credit guarantee to cover “life extension” of any of the insureds beyond their calculated life expectancy, and a credit wrap are purchased for $8 mm. Interest on a bridge loan and other short term financing are paid for $1 mm. An administrative services provider is retained for $8 mm. The residue of $40 mm is used to pay miscellaneous expenses, fine-tune pricing and to make equity payments to the bond issuer after redemption of the bond.

Other Capital Market Products

It will be understood that while the invention has been described in terms of the use of a novel, carefully structured pool of life settlement policies to collateralize a bond issue the invention includes other financial processes, strategies and instruments that employ such a novel pool of life settlement policies. For example, with or without enhancements such as the purchase of GICs, the life settlement pool can be structured to provide a stochastically determined future revenue payment or payment stream for any desired purpose. Such purpose may include the collateralization or other backing of other capital market products such as bills or notes or other debt instruments or even equities.

For example, an equity product such as a corporate stock flotation, could be created to capitalize on a rolling stream of future revenue derived from a revolving life insurance policy pool that is continuously replenished, by additional selection and purchase, using benefits from expiring policies, according to the principles of the invention described herein. Preferably, the policies are selected according to actuarial principles to provide an expectation of specific revenues at specific time intervals, e.g. annually, or in intervals of from two to five years each, such as to yield dividends, stock appreciation or interest payments according to a desired future projection. Life extension insurance, credit enhancement and other such financial dressing described herein may be employed to enhance the novel life policy backed capital product, as desired.

Referring now to FIG. 8, the structure of life-settlement collateral product 72 (FIG. 4) can be seen in relative isolation to facilitate a better understanding of its operation and its possible use in structuring a variety of new or enhanced capital market products including not only short, medium or long-term bonds and notes, but also equity-based investment vehicles or securities, mixed debt-equity instruments and derivatives or other investment vehicles.

As previously described, collateral product 72 comprises a qualified pool of life settlement policies, life settlement policy pool 18, together with one or more income-bearing or other suitable financial instruments deposited in sinking fund 76, which cooperate to provide a reasonable assurance that collateral product 72 will, at some future date, certain or uncertain, have a substantially greater value than the cost of assembling the component parts, which profit may be extracted as a return on investment, if desired. By carefully selecting the policies incorporated in life settlement policy pool 18 to ensure the receipt of death benefit payments within a planned time frame and including in the collateral product a suitable income instrument that will provide liquidity to pay the policy premiums, it is possible to minimize the risk of default or loss of value of life-settlement collateral product 72.

Preferably, the policies in life settlement policy pool 18 are selected in a rigorous screening process such as that described with reference to FIG. 6, in order to optimize the expectation of death benefits within a given time frame, for example, but not necessarily within the fixed term of a bond collateralized by life-settlement collateral product 72. In particular, it is desirable to include a policy due diligence process 106 to screen policies available from policy sources 12 to enhance the probability of the timely payment of death benefits upon the death of insureds whose policies have been assigned to life settlement policy pool 18. It is furthermore desirable to employ actuary table 102 when screening policies to be assigned, to help manage the financial structure of life settlement policy pool 18, particularly with regard to the timing of the receipt of the anticipated death benefits.

For an equity product, the financial instruments included in collateral product 72 with life settlement policy pool 18 may, if desired be limited to those instruments that will assure payment of the policy premiums, for example GIC A or an equivalent product. Stockholders in such an equity product may receive their share of death benefits, as and when deaths occur and the benefits are received, as distributions from time to time, as stock distributions or appreciation, or in other known manner as will be apparent to those skilled in the art. In structuring such an equity product, other financial instruments may be included, if desired, for example an income-producing instrument akin to GIC B, to generate dividends or interest payments, payable to the stockholders, in the period prior to receipt of death benefits. The financial instruments included in life-settlement collateral product 72 can be purchased in any desired manner, for example by use of funds derived from shareholder equity, or by a loan, and so on.

Benefits of the Invention

As described hereinabove, the present invention provides a securitized life settlement capital market product which can be structured to be an attractive fixed-income investment, in the form of a bond or other indenture, collateralized with purchased life insurance policies. The inventive capital market product is designed specifically to limit the risk of the investment. It is contemplated that the returns offered to the investor on the inventive bond or other capital vehicle may exceed returns for fixed-income securities with similar risk and credit-rating characteristics.

Summarizing, a preferred embodiment of the inventive method uses purchased life insurance policies that have increased in value subsequent to their issuance, owing to life expectancy changes, as collateral for a AA-rated Rule 144A bond offering. The bond has a seven-year maturity and a coupon of 100 to 125 basis points over the yields for Treasury bills or bonds with the desired terms to maturity.

A comprehensive risk-management approach can be employed to control investor or operational risk by:

pre-funding the costs of supporting the issued bond thereby making the bond bankruptcy-remote, which is to say that bankruptcy of the issuer does not imply default on the bond;

ensuring that only highly-qualified policies pass a stringent screening process from medical, actuarial and legal compliance perspectives;

over-collateralizing the risk so that even under adverse circumstances the bond can perform well;

carefully designing the way in-force premium payments are managed and benefits are released to optimize cash flow;

maintaining capital reserves that can be trimmed significantly in the event of positive experience with mortality assumptions; and

acquiring insurance coverage to release the value of life settlement policies outstanding at the end of the bond term to ensure payment of all bond obligations in a timely manner.

In practicing the invention as described herein, bond issuer 10 can reduce the bond investor's risk by setting aside amounts for major obligations at the outset of the term and then wrapping the structure with a bond credit guarantee and coverage and a credit conversion facility. Thus, the fixed-income bond offering can be dynamically supported by aligning the components of the financial structure of the bond in such a way that many of the obligations are quantified and addressed up front.

The effective acquisition and management of primary collateral, life settlement policy pool 18, helps create an attractive and robust security for the bonds.

Modeling of the financial and economic implications of preferred embodiments of the life settlement bond 92 of the invention under a range of primary collateral and interest rate scenarios suggests that such a bond can generate competitive returns for bondholders with an acceptable credit-risk profile while providing attractive returns for equity holders, under a range of reasonable possible real world events.

By guaranteeing that all premium payments are made and the life insurance policies are kept in force, the invention enables value to be captured as compared with an average pool of polices which can be expected to suffer a considerable percentage of defaults. Conventionally, the default rate may be 10 or 15 percent or higher, leading to loss of death benefits.

Computer Implementation

Each of the processes and products described herein may be computer implemented, if desired, as will be apparent to those skilled in the art, using suitable software and/or programming. The invention includes a computer implementing such software and/or programming and having stored in accessible permanent memory data descriptive of the financial products and instruments, documents and other products described herein which data may be retrieved and displayed on screen, printed, emailed, networked or otherwise utilized in known manner. In particular, the invention includes, inter alia, computer-implemented display or generation of an indenture for the inventive life settlement bond and of an inventory of the policies in life settlement policy pool 18 with salient particulars.

The term “computer” is employed broadly in this context to substantially any data processing device capable of performing the described functions and is not limited to desktop, laptop, handheld and other computers which are of course intended to be included in the scope of the term as are data processing-enabled appliance-like devices such as computerized cell phones.

Disclosures Incorporated

The entire disclosure of each and every United States patent and patent application, each foreign and international patent publication, of each other publication and of each unpublished patent application that is referenced in this specification or elsewhere in this patent application, is hereby incorporated herein, in its entirety, by the respective specific reference that has been made thereto.

While illustrative embodiments of the invention have been described above, it is, of course, understood that many and various modifications will be apparent to those of ordinary skill in the relevant art, or may become apparent as the art develops. Such modifications are contemplated as being within the spirit and scope of the invention or inventions disclosed in this specification.

1. A securitized life settlement bond comprising a commercial bond collateralized by a pool of life settlement policies each bearing death benefits wherein the policies are selected from available policies for death benefit collectability, the death benefits collected being usable for redemption of the bond.

2. A life settlement bond according to claim 1 wherein the bond is issued by a bond issuer, has a term for redemption and each life settlement policy in the life settlement policy pool has an insured party wherein the life expectancy of each insured party is less than the term of the bond and wherein optionally each life expectancy is freshly determined on behalf of the bond issuer prior to inclusion in the life settlement policy pool.

3. A life settlement bond according to claim 2 wherein the life expectancy of each insured party is at least one year less than the term of the bond.

4. A life settlement bond according to claim 2 wherein the life settlement policies comprise multiple cohorts having different life expectancies.

5. A life settlement bond according to claim 4 wherein the life settlement policies are organized into from two to five cohorts each cohort having a proportion of the total face value of policies in the life settlement policy pool within about 30 percent of an equal proportion.

6. A life settlement bond according to claim 2 wherein the life settlement bond has a term in the range of from about 5 to about 10 years and wherein the life settlement policy pool comprises policies having insured parties having life expectancies at least two years less than the term of the bond.

7. A life settlement bond according to claim 1 wherein all the insured parties have life expectancies in the range of from about 2 to about 12 years from the date of issuance of the life settlement bond.

8. A life settlement bond according to claim 1 wherein each life insurance policy has a face value of from about $250,000 to about $5 million.

9. A life settlement bond according to claim 1 wherein the life settlement policy pool comprises from about 200 to about 1,000 policies.

10. A life settlement bond according to claim 1 wherein the bond is issued by a bond issuer and has a term for redemption, wherein each life settlement policy in the life settlement policy pool has an insured party, the life expectancy of each insured party being less than the term of the bond, wherein the life settlement policies comprise from two to five cohorts of policies each cohort having a proportion of the total face value of policies in the life settlement policy pool within about 30 percent of an equal proportion.

11. A life settlement bond according to 2 wherein the life settlement policies are organized into from two to five cohorts having different life expectancies, each cohort having a proportion of the total face value of policies in the life settlement policy pool within about 30 percent of an equal proportion, wherein all the insured parties have life expectancies in the range of from about 2 to about 12 years from the date of issuance of the life settlement bond wherein each life insurance policy has a face value of from about $250,000 to about $5 million and wherein the life settlement policy pool comprises from about 200 to about 1,000 policies.

12. A life settlement bond according to claim 1 wherein the life settlement policies are subject to recurring premium payments and wherein collateral for the life settlement bond comprises a financial instrument or group of financial instruments structured to provide recurring income payments enabling payment of the recurring premiums.

13. A life settlement bond according to claim 1 wherein the financial instrument or instruments comprise a guaranteed investment contract or contracts, respectively, purchased from a financial institution having a rating of at least A.

14. A life settlement bond according to claim 1 wherein the life settlement bond is subject to regular coupon payments and wherein collateral for the bond comprises a financial instrument or group of financial instruments structured to provide recurring income payments enabling the coupon payments.

15. A life settlement bond according to claim 1 wherein the financial instrument or instruments comprise a guaranteed investment contract or contracts, respectively, purchased from a financial institution having a rating of at least A.

16. A life settlement bond according to claim 1 wherein collateral for the life settlement bond comprises life extension insurance providing for an insurance carrier to guarantee to purchase or loan funds, optionally at full face value, on policies having insured parties living beyond their actuarially opined life expectancies.

17. A life settlement bond according to claim 1 wherein the life extension insurance comprises a life extension contract providing that payment be made to an issuer or trustee of the bond at the end of the year of life expectancy assigned to a given policy if the insured party is still living and optionally, if insufficient funds exist to pay bond obligations.

18. A life settlement bond according to claim 1 wherein the life settlement bond includes a bond insurance contract with an insuring financial institution to assure the performance of the life settlement bond with respect to the bond payment obligations.

19. A life settlement bond according to claim 1 wherein issuance of the life settlement bond is implemented under legislation providing for lots in the bond to be sold exclusively to institutional investors.

20. A life settlement bond according to claim 1 wherein the life settlement bond is issued by a bond issuer and the bond issuer owns the life settlement policies in the pool.

21. A life settlement bond according to claim 1 wherein the life settlement policy pool is held in a bond trust dedicated to servicing and redeeming the bond and wherein benefits payable on the life policies in the pool are receivable into the bond trust.

22. A life settlement bond according to claim 1 wherein the life settlement bond is issued by a bond issuer and the bond issuer owns the entire rights to benefits deriving from the life settlement policies in the life settlement policy pool.

23. A life settlement bond according to claim 1 wherein the bond has a face value and the aggregate face value of the policies in the life settlement policy pool is within twenty percent of the bond face value.

24. A life settlement bond according to claim 1 wherein the bond has a term for redemption of from about 5 to about 10 years.

25. A life settlement bond according to claim 1 wherein the bond has a face value and the aggregate face value of the policies in the life settlement policy pool is at least about 8 percent greater than the bond face value.

26. A life settlement bond according to claim 1 wherein the bond has a face value of from about $100 million to about $1 billion.

27. A life settlement bond according to claim 1 wherein the bond has a coupon of from about 50 to 200 basis points over the corresponding U.S. Treasury bond yield.

28. A life settlement bond according to claim 1 wherein the bond has a term of from about 5 to about 10 years and a face value of from about $100 million to about $1 billion, wherein the aggregate face value of the policies in the life settlement policy pool is at least about 8 percent greater than the bond face value, and wherein the bond has a coupon of from about 50 to 200 basis points over the corresponding U.S. Treasury bond yield.

29. A life settlement bond according to claim 1 wherein the bond is issued by a bond issuer and has a term for redemption of from about 5 to about 10 years;
wherein each life settlement policy in the life settlement policy pool has an insured party, the life expectancy of each insured party being less than the term of the bond;
wherein the life settlement policies comprise from two to five cohorts of policies each cohort having a proportion of the total face value of policies in the life settlement policy pool within about 30 percent of an equal proportion;
wherein the life settlement policies are subject to recurring premium payments;
wherein collateral for the life settlement bond comprises a financial instrument or group of financial instruments structured to provide recurring income payments enabling payment of the recurring premiums;
wherein the life settlement bond is subject to regular coupon payments;
wherein collateral for the bond comprises a financial instrument or group of financial instruments structured to provide recurring income payments enabling the coupon payments;
wherein the bond has a face value of from about $100 million to about $1 billion;
wherein the aggregate face value of the policies in the life settlement policy pool is at least about 8 percent greater than the bond face value; and
wherein the bond has a coupon of from about 50 to 200 basis points over the corresponding U.S. Treasury bond yield.

30. A securitized life settlement interest-paying bond issued by a bond issuer, the bond having:
a) a face value of from about $10 million to about $1 billion;
b) a term for redemption of from 5 to 10 years; and
c) a coupon payable annually or semi-annually;
wherein the bond is collateralized by a collateral product comprising:
d) a life settlement policy pool comprising from 100 to 1,000 life insurance policies, the policies being divided into from two to five cohorts of policies, the policies in each cohort having different life expectancies from the policies in other cohorts and having an aggregate face value at least about 8 percent greater than the bond face value wherein each life insurance policy in the pool:
i) bears death benefits;
ii) has an insured party, the life expectancy of each insured party being less than the term of the bond; and
iii) is subject to payment of recurring premiums;
e) a first financial instrument or group of financial instruments structured to provide recurring income payments to provide funds for making the bond coupon payments; and
f) a second financial instrument or group of financial instruments structured to provide recurring income payments to provide funds for payment of the recurring premiums;
wherein death benefits can be collected on the life insurance policies in the life settlement policy pool, the death benefits being usable for redemption of the bond.

31. A securitized life settlement bond according to claim 30 wherein the coupon has an interest rate of from about 50 to about 200 basis points over a corresponding U.S. Treasury bond yield and wherein proportion of the total face value of policies in each cohort of policies is within about 30 percent of an equal proportion based upon the face value of an equal proportion.

32. A capital market product having a face value and being collateralized by a collateral product comprising
a) a life settlement policy pool of life insurance policies bearing death benefits and subject to payment of recurring premiums to maintain the death benefits in force, the policies being selected to provide an expectation of the receipt of death benefit payments within a planned time frame, the death benefits having an aggregate value at least as great as the face value of the capital market product; and
b) an income instrument portfolio to generate income to provide funds to pay the life insurance policy premiums.

33. A capital market product according to claim 32 selected from the group consisting of short-, medium- and long-term bonds and notes, equity-based investment vehicles and securities, mixed debt-equity instruments and derivatives and other investment vehicles.

34. A method of servicing and redeeming a bond comprising:
a) making recurring interest payments from income received from an income instrument portfolio maintained in a bond trust; and
b) redeeming the bond with death benefit funds received from a pool of life insurance policies maintained in the bond trust.

35. A method according to claim 34 comprising:
c) paying premiums on the life insurance policies from income received from a further income instrument portfolio maintained in a bond trust.

36. A method according to claim 35 wherein the death benefit funds include bond credit guarantee payments for insureds outliving their calculated life expectancies.

37. A method of issuing a bond having a term comprising assembling a collateral product comprising a pool of life insurance policies bearing death benefits calculated to be receivable within the bond term, the life insurance policies being subject to recurring premium payments and the collateral product further comprising an income instrument portfolio providing income for making the premium payments and the method further comprising collateralizing the bond with the collateral product and issuing the bond.
